(19) United States
(12) Patent Application Publication
(10) Pub. No.: US 2014/0149169 A1
(43) Pub. Date: May 29, 2014

(54) IMPACT ANALYSIS METHOD, IMPACT ANALYSIS APPARATUS AND NON-TRANSITORY COMPUTER-READABLE STORAGE MEDIUM

(71) Applicant: Ryo Nakano, Tokyo (JP)

(72) Inventor: Ryo Nakano, Tokyo (JP)

(73) Assignee: Hitachi ,Ltd.

(21) Appl. No.: 14/006,228

(22) PCT Filed: Jun. 8, 2011
(86) PCT No.: PCT/JP2011/063115

§ 371 Date: Feb. 10, 2014

(51) Int. Cl. G06Q 10/06

(52) U.S. Cl. CPC G06Q 10/06312
USPC 705/7.22

(57) ABSTRACT

Provided is an impact analysis method in which a management computer acquires configuration information that defines configuration elements of the hardware and configuration elements of the software, and relation information between the configuration elements of the hardware and the configuration elements of the software, influence definition information that defines influences among the configuration elements of the configuration information, in time-series information that defines information related to operation of the software in time-series, and determines an influence of the configuration elements of the hardware on the configuration elements of the software on a basis of operation states in time-series defined by the time-series information from the relation information and the influence definition information to determine a configuration element of the software that is influenced by the hardware among the configuration elements of the software in the time band.

### BACKGROUND

The present invention relates to management of a computer system, and particularly to a technique of ascertaining the influence range when a computer is stopped in a data center or other types of systems.

Conventionally, a configuration information database for managing hardware configurations and software configurations has been used in a computer system employing a number of computers, such as a data center (for example, see Patent Literature 1). As for the businesses (or services) provided by the data center or the like, usually, one business is provided with a plurality of computers working with each other. Therefore, the configuration information database has a function of impact analysis for acquiring the range of business that would be influenced by the stop of a particular computer. The use of the impact analysis makes it possible to ascertain the range of the business influenced by the stop of the operating computer due to maintenance or the like.
Patent Literature 1: Japanese Unexamined Patent Application Publication No. 2008-59599

### SUMMARY

In the above conventional example, it is possible to identify the range of the business influenced by the stop of a particular computer at the present point but not possible to identify the correct influence range in the configuration where the operation and non-operation of the business (or job) are switched according to the time passage or a time band.

In particular, in the conventional example, there is a problem that the impact analysis based on the time axis such as the schedule of the business cannot be conducted. Furthermore, in the above conventional example, there is another problem that it is difficult to define the influence in the impact analysis based on the business impact relative to the business to be provided.

Additionally, in the above conventional example, there is another problem that when the maintenance is carried out with a particular computer stopped, it is necessary for an administrator or the like to manually plan the time when the computer is stopped in consideration of the operation schedule of the job, which requires much labor.

In view of the above problems, an object of the present invention is to quickly calculate the range of influence on the business in the case of stopping a computer for a particular time in a circumstance where the operation and non-operation of the business to be executed in one or more computers change according to the time passage.

An aspect of the present invention is an impact analysis method in which a management computer including a processor and a memory analyzes an influence on software from hardware in a computer system, the method comprising: a first step in which the management computer receives a time band for which the analysis is conducted; a second step in which the management computer acquires configuration information that defines configuration elements of the hardware and configuration elements of the software, and relation information between the configuration elements of the hardware and the configuration elements of the software; a third step in which the management computer acquires influence definition information that defines influences among the configuration elements of the configuration information; a fourth step in which the management computer reads in time-series information that defines information related to operation of the software in time-series; a fifth step in which the management computer determines an influence of the configuration elements of the hardware on the configuration elements of the software on a basis of operation states in time-series defined by the time-series information from the relation information and the influence definition information to determine a configuration element of the software that is influenced by the hardware among the configuration elements of the software in the time band; and a sixth step in which the management computer outputs the configuration element of the software that is influenced by the hardware in time-series including the time band.

An aspect of the present invention can determine in time-series and provide quickly the range where software configuration elements are influenced by stop of a hardware configuration element for a particular time under a circumstance where the operation states of software configuration elements to be executed by hardware configuration elements change according to the time passage.

### BRIEF DESCRIPTION OF DRAWINGS

FIG. 1 is a block diagram depicting an example of a computer system according to a first embodiment of the present invention.

FIG. 2 is a block diagram depicting an example of a configuration management server according to the first embodiment of the present invention.

FIG. 3 is a block diagram depicting an example of a job management server and a job execution server according to the first embodiment of the present invention.

FIG. 4A is a diagram depicting an example of the configuration information on hosts according to the first embodiment of the present invention.

FIG. 4B is a diagram depicting an example of the configuration information on agents according to the first embodiment of the present invention.

FIG. 4C is a diagram depicting an example of the configuration information on a manager according to the first embodiment of the present invention.

FIG. 4D is a diagram depicting an example of the configuration information on a job group according to the first embodiment of the present invention.

FIG. 4E is a diagram depicting an example of the configuration information on job nets according to the first embodiment of the present invention.

FIG. 4F is a diagram depicting an example of the configuration information on jobs according to the first embodiment of the present invention.

FIG. 4G is a diagram depicting an example of the relation among the configuration information according to the first embodiment of the present invention.

FIG. 5 depicts a screen image of the window representing the relation among the configuration information according to the first embodiment of the present invention.

FIG. 6 is a diagram depicting an example of the influence definition information according to the first embodiment of the present invention.

FIG. 7 is a diagram depicting an example of the schedule information according to the first embodiment of the present invention.

FIG. 8 depicts a screen image of the window representing the influence analysis result at 0:00 according to the first embodiment of the present invention.

FIG. 9 depicts a screen image of the window representing the influence analysis result at 1:00 according to the first embodiment of the present invention.

FIG. 10 depicts a screen image of the window representing the influence analysis result at 2:00 according to the first embodiment of the present invention.

FIG. 11 depicts a screen image of the window for specifying the time of the influence analysis according to the first embodiment of the present invention.

FIG. 12A is a diagram depicting an example of the influence analysis result information according to the first embodiment of the present invention.

FIG. 12B is a diagram depicting an example of the influence analysis result information according to the first embodiment of the present invention.

FIG. 12C is a diagram depicting an example of the influence analysis result information according to the first embodiment of the present invention.

FIG. 12D is a diagram depicting an example of the influence analysis result information according to the first embodiment of the present invention.

FIG. 13 depicts a screen image of the window representing the hourly influence analysis result according to the first embodiment of the present invention.

FIG. 14 is a flowchart of an example of an influence analysis process according to the first embodiment of the present invention.

FIG. 15 is a flowchart of an example of the process of Step S6 in FIG. 14 according to the first embodiment of the present invention.

FIG. 16 is a flowchart of an example of the process of Step S17 in FIG. 15 according to the first embodiment of the present invention.

FIG. 17 is a diagram depicting the summary of the process for obtaining a release plan according to the first embodiment of the present invention.

FIG. 18 is a flowchart of an example of the release plan calculation process according to the first embodiment of the present invention.

FIG. 19 is a flowchart of an example of the process of Step S41 in FIG. 18 according to the first embodiment of the present invention.

FIG. 20 is a diagram depicting an example of the transmission number information according to the first embodiment of the present invention.

FIG. 21 is a diagram depicting an example of the release plan result information according to the first embodiment of the present invention.

FIG. 22 is a diagram depicting an example of the time influence coefficient information according to a second embodiment of the present invention.

FIG. 23 depicts a screen image of the window representing the hourly influence analysis result according to the second embodiment of the present invention.

FIG. 24 is a flowchart of an example of the influence analysis process according to the second embodiment of the present invention.

FIG. 25 is a flowchart of an example of the process of Step S6A in FIG. 24 according to the second embodiment of the present invention.

FIG. 26 is a flowchart of an example of the process of Step S17A in FIG. 25 according to the second embodiment of the present invention.

FIG. 27 is a flowchart of an example of the process for automatically generating a release schedule according to the second embodiment of the present invention.

FIG. 28 is a diagram depicting an example of the transmission number information according to the second embodiment of the present invention.

FIG. 29 depicts a screen image of the window representing the hourly influence analysis result according to a third embodiment of the present invention.

FIG. 30 is a flowchart of an example of the influence analysis process according to the third embodiment of the present invention.

FIG. 31 is a flowchart of an example of the process of Step S6B in FIG. 30 according to the third embodiment of the present invention.

FIG. 32 is a flowchart of an example of the process for automatically generating the release plan according to the third embodiment of the present invention.

FIG. 33 is a diagram depicting an example of the transmission number information according to the third embodiment of the present invention.

FIG. 34 is a diagram depicting an example of the schedule information according to a fourth embodiment of the present invention.

FIG. 35 is a diagram depicting the summary of a failure influence analysis process according to the fourth embodiment of the present invention.

FIG. 36 depicts a screen image of the window representing the hourly influence analysis result according to the fourth embodiment of the present invention.

### DESCRIPTION OF EMBODIMENTS

Embodiment of the present invention will hereinafter be described with reference to the attached drawings.

### First Embodiment

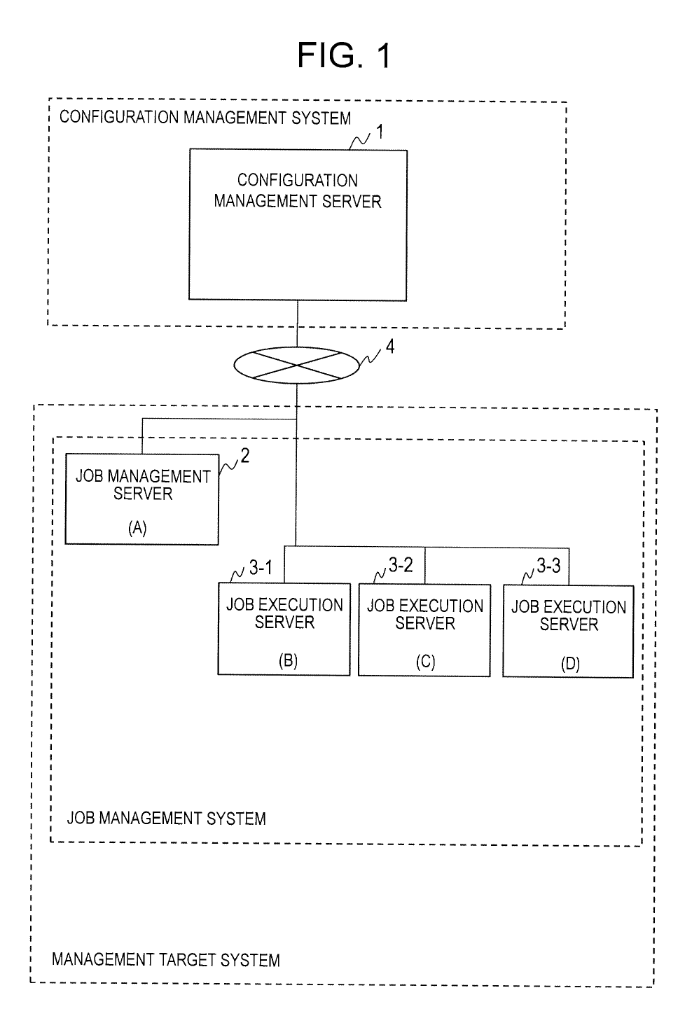

FIG. 1 is a block diagram depicting an example of a computer system according to a first embodiment of the present invention. A computer system of the present invention comprises a job management system for providing businesses (or jobs), and a configuration management system for managing a plurality of job management systems as a management target system. If the number of job management systems is one, the management target system is equivalent to the job management system. In the example below, one job management system constitutes the management target system.

The job management system includes a plurality of job execution servers 3-1 to 3-3 for executing jobs (software), and a job management server 2 for managing the job execution servers 3-1 to 3-3. In the description below, the job execution servers are collectively denoted by a reference symbol 3. Each job execution server 3 and the job management server 2 are connected to a configuration management server 1 via a network 4.

A client computer, which is not shown, connected to the network 4 is provided with the business through the job executed by the job execution server 3. The business may consist of one job, or one business may include a plurality of jobs (job net).

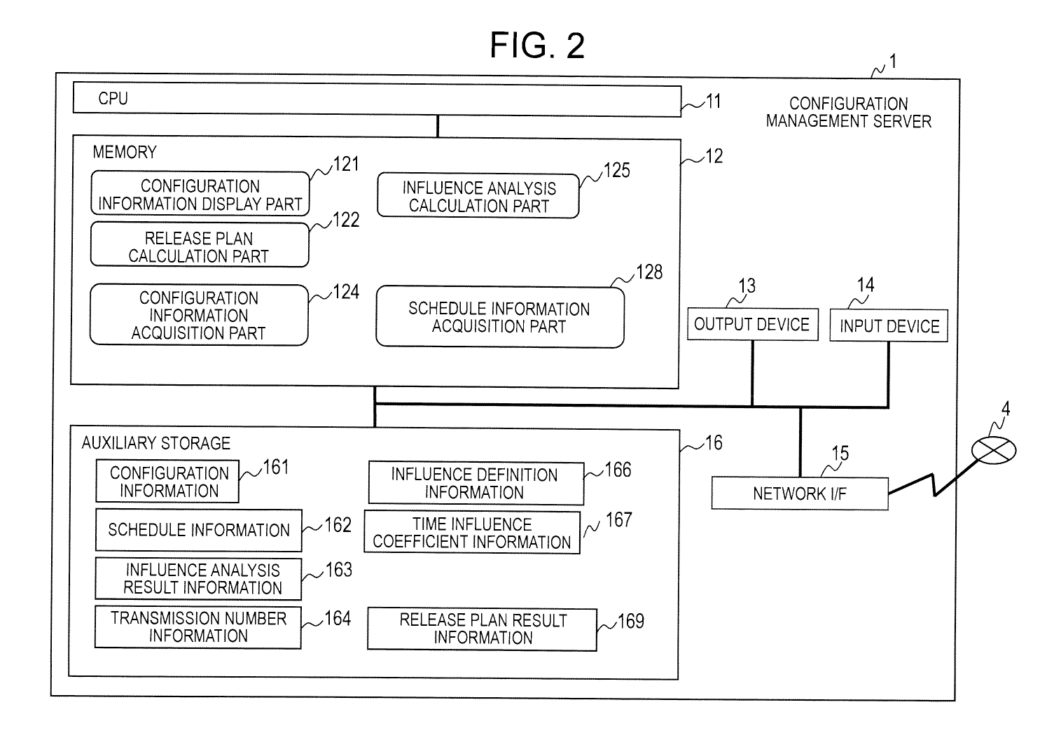

FIG. 2 is a block diagram depicting an example of the configuration management server 1 according to the first embodiment. The configuration management server 1 comprises: a processor 11 for performing calculation; a memory 12 for storing data or a program; an output device 13 including a display or the like; an input device 14 including a keyboard, a mouse, or the like; a network interface 15 used for the connection to the network 4; and an auxiliary storage device 16 for holding the data or the program.

Programs for managing the job management system as the management target system are loaded into the memory 12 and executed by the processor 11. Examples of the programs include a configuration information display part 121, an influence analysis calculation part 125, a release plan calculation part 122, a configuration information acquisition part 124, and a schedule information acquisition part 128.

The auxiliary storage device 16 stores the information used by the above functional parts. The auxiliary storage device 16 stores configuration information 161 storing the configuration element acquired from the job management system, schedule information 162 storing an execution schedule acquired from the job management server 2, influence definition information 166 defining the influence between the configuration elements, time influence coefficient information 167 defining in advance the influence coefficient for each time band, influence analysis result information 163, transmission number information 164, and release plan information 169.

The configuration information acquisition part 124 acquires the configuration element from the job management system at a predetermined timing (or predetermined cycle) and updates the configuration information 161. The schedule information acquisition part 128 acquires schedule information 261 from the job execution server 2 at a predetermined timing (or predetermined cycle) and updates the schedule information 162 in the configuration management server 1. Upon the reception of the order from the input device 14, the influence analysis calculation part 125 calculates the range of an influence on the business on the basis of the configuration information 161 and the schedule information 162, and outputs the calculation result to the output device 13. Upon the reception of the order from the input device 14, the release plan calculation part 122 calculates the job execution server 3 which can be stopped, on the basis of the configuration information 161 and the schedule information 162, and outputs the calculation result to the output device 13.

A failure influence analysis part 127 calculates the range of the business influenced in the occurrence of a failure on the basis of the configuration information 161 and the schedule information 162, and outputs the calculation result to the output device 13 as later described. The configuration information display part 121 outputs the configuration information 161 to the output device 13 in response to the order from the input device 14.

The processor 11 operates as a functional part for achieving a predetermined function by operating based on the program of any of the function parts. For example, the processor 11 functions as the influence analysis calculation part 125 by operating based on an influence (impact) analysis program. This similarly applies to other programs. Moreover, the processor 11 operates as a functional part for achieving each of a plurality of processes to be executed by each program. A computer and a computer system correspond to an apparatus and a system including these functional parts, respectively.

The information such as a program or a table for achieving each function of the configuration management server 1 can be stored in the auxiliary storage device 16. The auxiliary storage device 16 consist of, for example, one or more storage devices such as a nonvolatile semiconductor memory, a hard disk drive, or an SSD (Solid State Drive), or a non-transitory computer-readable data storage medium such as an IC card, an SD card, or a DVD.

The configuration management server 1 as a management computer analyzes the influence on the software from the hardware of the management target system, and outputs the analysis result to the output device 13. As the configuration elements of the hardware, a computer for executing a program included in the business of the job execution servers 3 and the like is included. As the configuration element of the software, one or more programs executed in the computer are included. The business is provided to a client computer, which is not shown, by the one or more programs. In other words, the business is provided by the one or more programs to be executed by one or more computers.

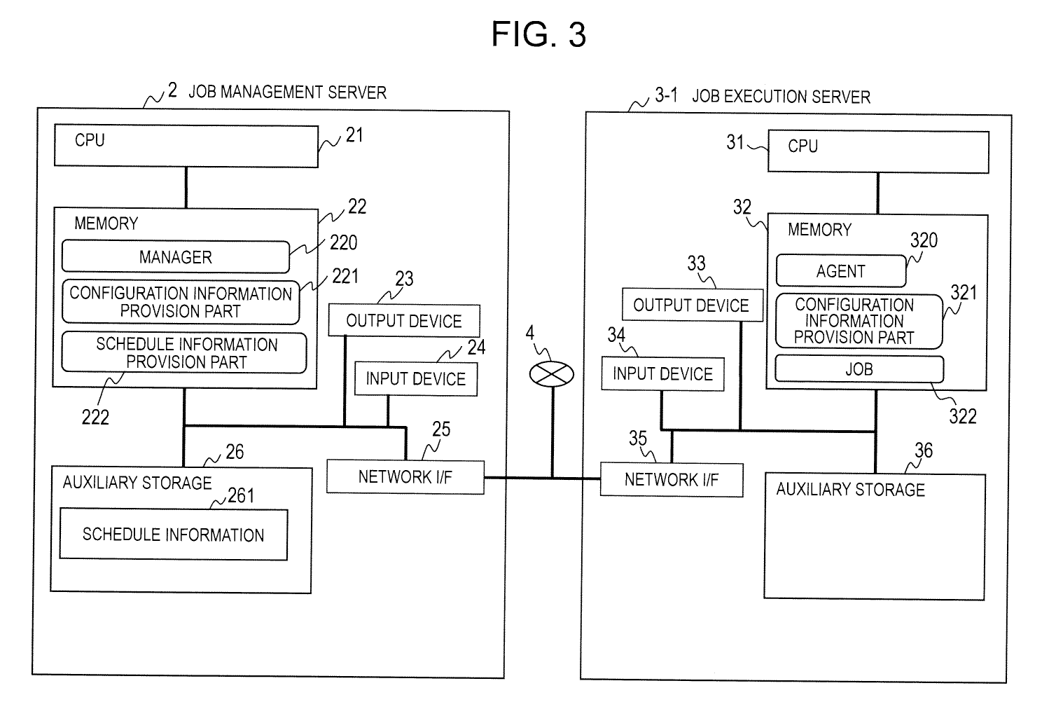

FIG. 3 is a block diagram depicting one example of the job management server 2 and the job execution server 3-1 in the first embodiment of the present invention. Note that the job execution servers 3-2 and 3-3 depicted in FIG. 1 also have the same configuration as the job execution server 3-1.

The job management server 2 comprises: a processor 21 for performing a calculation process; a memory 22 for storing data or a program; an output device 23 including a display or the like; an input device 24 including a keyboard, a mouse, or the like; a network interface 25 used for the connection to the network 4; and an auxiliary storage device 26 for holding the data or the program.

A program for managing the job management servers 3 is loaded into the memory 22 and executed by the processor 21. As one example of the program, a manager 220, a configuration information provision part 221, and a schedule information provision part 222 are included. The configuration information provision part 221 notifies the configuration management server 1 of the configuration information of the job management server 2. Moreover, the schedule information provision part 222 notifies the configuration management server 1 of the schedule information 261.

The auxiliary storage device 26 stores the information used by the above functional parts. The auxiliary storage device 26 stores, for example, the schedule information 261.

The manager 220 manages the jobs to be executed by the job management servers 3 via agents 320 of the job management servers 3-1 to 3-3 on the basis of the schedule information 261.

The job execution server 3-1 comprises: a processor 31 for performing a calculation process; a memory 32 for storing data or a program; an output device 33 including a display or the like; an input device 34 including a keyboard, a mouse, or the like; a network interface 35 used for the connection to the network 4; and an auxiliary storage device 36 for holding the data or the program.

The agent 320 for executing a job 322 is loaded to the memory 32 and executed by the processor 31. Further, a configuration information provision part 321 for notifying the configuration management server 1 of the configuration information is loaded to the memory 32.

The agent 320 executes one or more jobs 322 in response to the order from the manager 220 of the job management server 2.

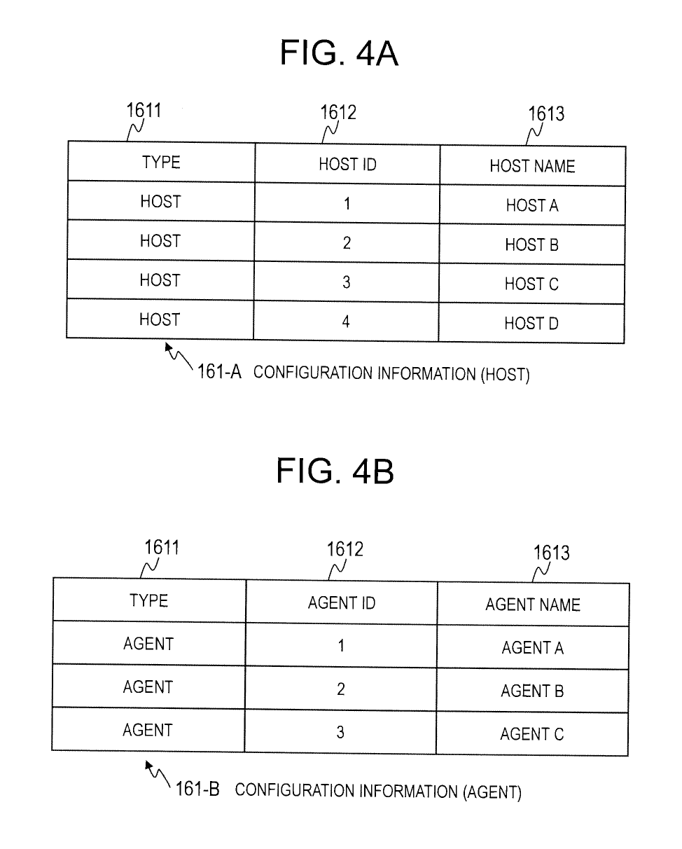

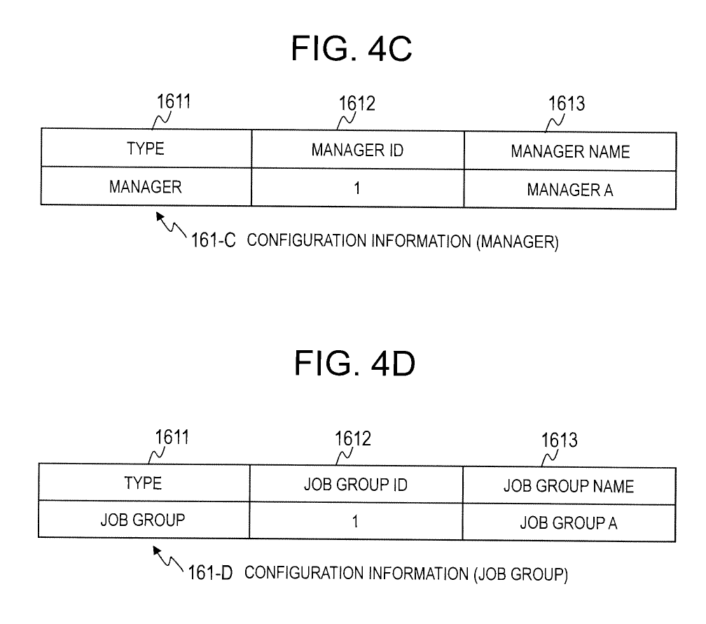

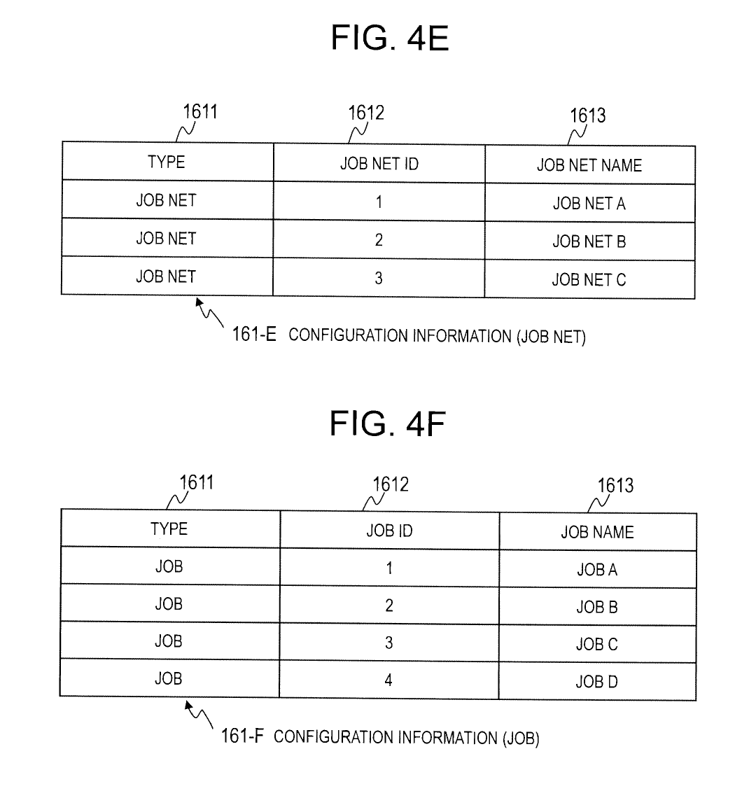

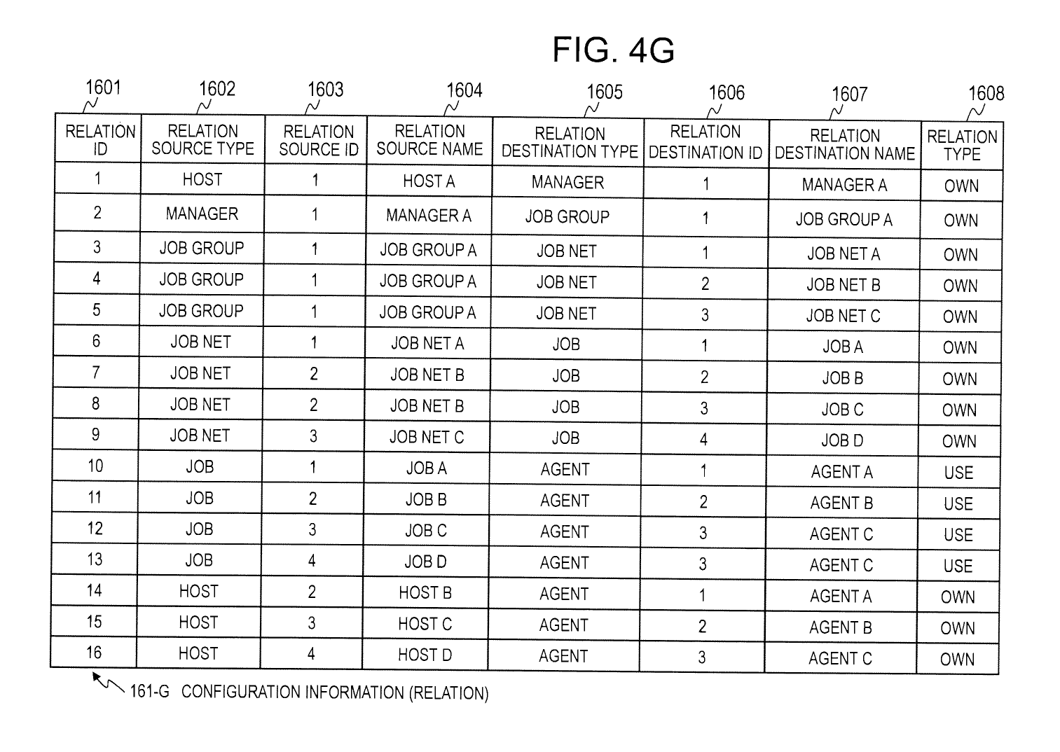

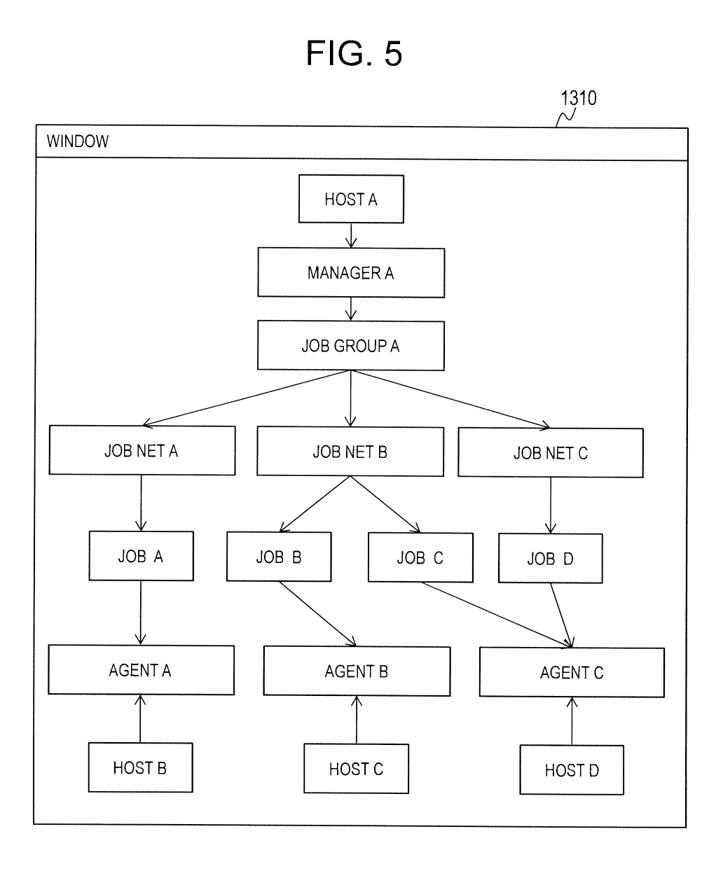

FIG. 4A to FIG. 4G and FIG. 5 each depict one example of the configuration information 161 managed by the configuration management server 1. The configuration information 161 managed by the configuration management server 1 is expressed in the form of topology as shown in FIG. 5. The configuration information 161 is configured in advance by the information for managing the configuration elements of the hardware and the configuration elements of the software. FIG. 5 depicts one example of a window 1310 of one management target system displayed in the output device 13 by the configuration information display part 121.

In the drawing, a host A corresponds to the job management server 2 of FIG. 1, and hosts B to D represent the job execution servers 3-1 to 3-3, respectively. In the drawing, a manager A corresponds to the manager 220 of FIG. 3. Agents A to C represent the agents 320 of the job execution servers 3. Jobs A to D represent the jobs 322 executed in the job execution servers 3-1 and 3-2.

The job management server 2 manages jobs nets A to C, each of which corresponds to a set of jobs, such as the unit of businesses, and jobs executed in the job execution server 3 by a job group A in which a plurality of job nets is the management unit. This embodiment describes an example in which the job management server 2 manages one job group A and the job group A includes the three job nets A to C. The job net A includes one job A executed in the agent A of the host B (job execution server 3-1). The job net B includes the job B executed in the agent B of the host C (job execution server 3-2) and the job C executed in the agent C of the host D (job execution server 3-3). The job net C includes the job D executed in the host D (job execution server 3-3).

The execution of the job A is managed by the agent A of the host B. The agent B of the host C manages the execution of the job B. The agent C of the host D manages the execution of the job C and the job D. Moreover, each of the job nets A to C is to provide the business.

In the example of the configuration information 161 described above, the host is defined as a hardware configuration element, and the agent, the job, and the manager are defined as software configuration elements. Moreover, the job net as the management unit of the job is defined as a software configuration element, and the job group as the management unit of the job net is defined as a software configuration element.

FIG. 4A is a diagram depicting an example of the configuration information 161-A on the host. One entry (or record) of the configuration information 161-A to 161-F includes a type 1611, an ID 1612, and a name 1613. In the case of the configuration information 161-A on the host, “host” is stored as the type 1611, the identifier of the host is stored as the ID 1612, and the name of the host is stored as the name 1613.

FIG. 4B is a diagram depicting an example of the configuration information 161-B on the agent. In the configuration information 161-B on the agent, “agent” is stored as the type 1611, the identifier of the agent is stored as the ID 1612, and the name of the agent is stored as the name 1613.

FIG. 4C is a diagram depicting an example of the configuration information 161-C on the manager. In the configuration information 161-C on the manager, “manager” is stored as the type 1611, the identifier of the manager is stored as the ID 1612, and the name of the manager is stored as the name 1613.

FIG. 4D is a diagram depicting an example of the configuration information 161-D on the job group. In the configuration information 161-D on the job group, “job group” is stored as the type 1611, the identifier of the job group is stored as the ID 1612, and the name of the job group is stored as the name 1613.

FIG. 4E is a diagram depicting an example of the configuration information 161-E on the job net. In the configuration information 161-E on the job net, “job net” is stored as the type 1611, the identifier of the job net is stored as the ID 1612, and the name of the job net is stored as the name 1613.

FIG. 4F is a diagram depicting an example of the configuration information 161-F on the job. In the configuration information 161-F on the job, “job” is stored as the type 1611, the identifier of the job is stored as the ID 1612, and the name of the job is stored as the name 1613.

FIG. 4G is a diagram depicting the configuration information 161-G on the relation among the elements of the configuration information depicted in FIG. 4A to FIG. 4F. One entry of the configuration information 161-G on the relation among the elements of the configuration information includes: a relation ID 1601 storing the identifier of the relation; a relation source type 1602 storing the type of a relation source; a relation source ID 1603 storing the identifier of an element of the relation source; a relation source name 1604 storing the name of the element of the relation source; a relation destination type 1605 storing the type of an element of a relation destination; a relation destination ID 1606 storing the identifier of the element of the relation destination; a relation destination name 1607 storing the name of the element of the relation destination; and a relation type 1608 storing the mode between the relation source and the relation destination. The configuration information 161-G on the relation of the element can store values configured by the administrator or the like through the input device 14, etc.

For the relation type 1608, one of “own” or “use” is configured. “Use” of the relation type 1608 indicates that the element of the relation source is used as the element of the relation destination. “Own” of the relation type 1608 indicates that the element of the relation source is owned by the element of the relation destination.

Here, the element of the relation source of the configuration information 161 represents the element serving as a start point of an arrow in the relation of the configuration information 161 shown in FIG. 5. The element of the relation destination of the configuration information 161 represents the element serving as an end point of the arrow in the relation of the configuration information 161 shown in FIG. 5.

The configuration information 161-G serves as the relation information defining the relation between the configuration element of the hardware and the configuration element of the software, and defines the relation between the hardware and the software, specifically, which host executes the agent or the job as the configuration element of the software, and defines the relation among the configuration elements of the software, specifically, which job is included in the job net. The relation among the configuration elements of the hardware may include a connection relation between network appliances such as a host and a router (not shown).

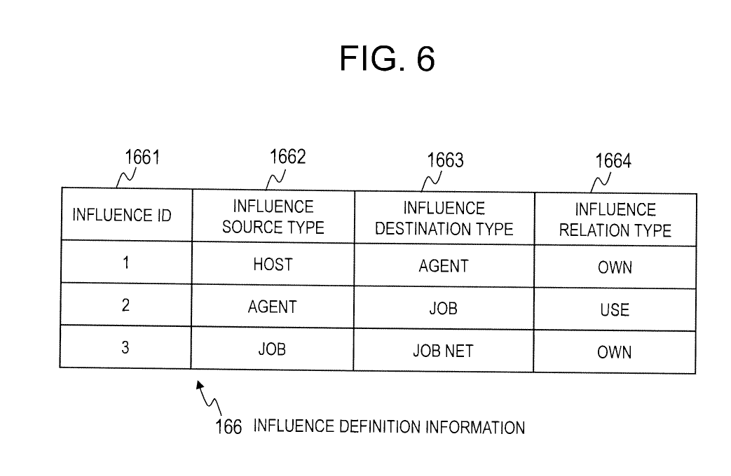

FIG. 6 is a diagram depicting an example of influence definition information 166 for defining the influence between the elements of the configuration information. One entry of the influence definition information 166 includes: an influence ID 1661 storing the identifier of an influence; an influence source type 1662 storing the type of the configuration information of an influence source; an influence destination type 1663 storing the type of the configuration information influenced by the influence source; and an influence relation type 1664 storing the relation type 1608 of the configuration information in the occurrence of the influence.

For example, when the agent is owned by the host, the agent is influenced by the host. In other words, if the host of the influence source type 1662 is stopped, the agent at the influence destination 1663 is also stopped.

If the influence analysis is conducted based on the influence definition information 166 and the configuration information 161-G on the relation of FIG. 4G, the analysis is conducted as described in the conventional example. For example, if the influence (impact) analysis when the hosts B to D are stopped is conducted in the configuration management server in the conventional example, only the relation of the configuration information 161 and the relation between the influence source and the influence destination of the influence definition information 166 are obtained. Therefore, in the obtained analysis result, all the job nets A to C on the agents A to C executed by the hosts B to D are stopped.

In view of this, in the present invention, the range of the job which is influenced by the stop of the hosts B to D is specified for each time band or time point by the use of the schedule information 162 of the job of the job management server 2.

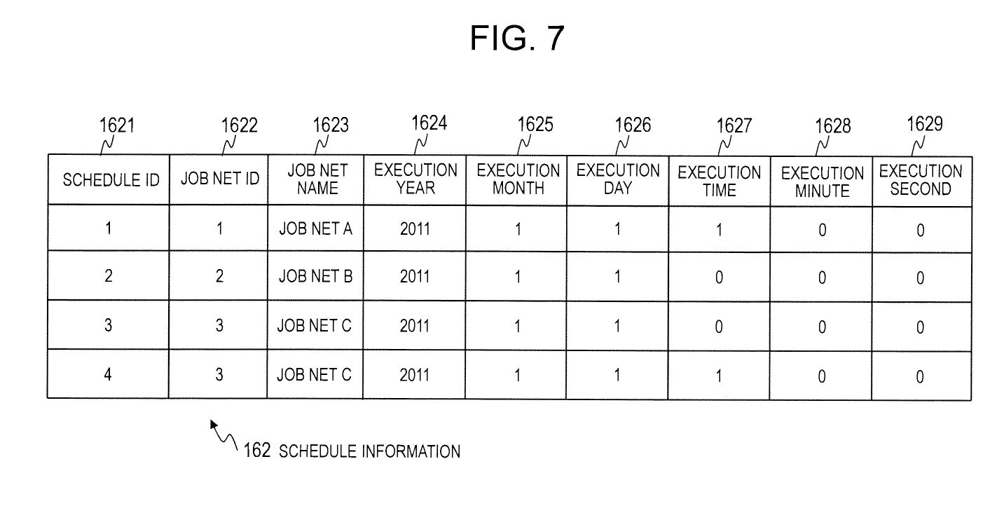

FIG. 7 depicts one example of the schedule information 162 storing the hourly execution schedule acquired from the job management server 2 by the schedule information acquisition part 128 of the configuration management server 1. One entry of the schedule information 162 includes a schedule ID 1621 storing the identifier of an execution schedule, a job net ID 1622 storing the identifier of the job net, a job net name 1623 storing the name of the job net, a year 1624, a month 1625, a day 1626, a time 1627, a minute 1628, and a second 1629 of the execution. The job included in the job net ID 1622 is executed for an hour from the year, month, day, time, minute, and second of the execution (1624 to 1629). For example, the job net A is executed for one hour from 1:00:00 to 1:59:59 on Jan. 1, 2011. As another example, the job net C is executed for two hours from 0:00:00 to 1:59:59 on Jan. 1, 2011.

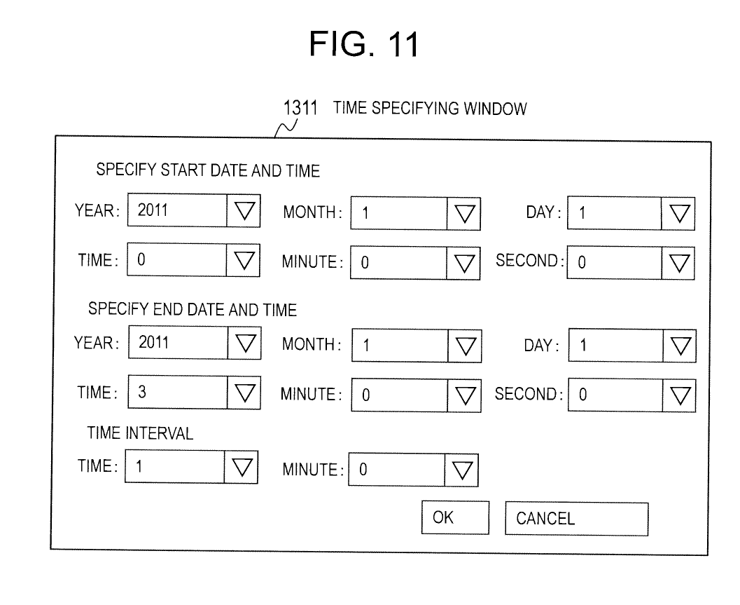

FIG. 11 depicts an example of a time specifying window 1311 displayed on the output device 13 by the influence analysis calculation part 125, the window receiving the range of conducting the influence analysis. The influence analysis calculation part 125 displays the window 1311 on the output device 13 and acquires from the manipulation of the input device 14, the start time, the end time, and the analysis time intervals for conducting the influence analysis when the hosts B to D are stopped. In the depicted example, the administrator or the like orders the configuration management server 1 to conduct the influence analysis every hour from 1:00:00 to 3:00:00 on Jan. 1, 2011.

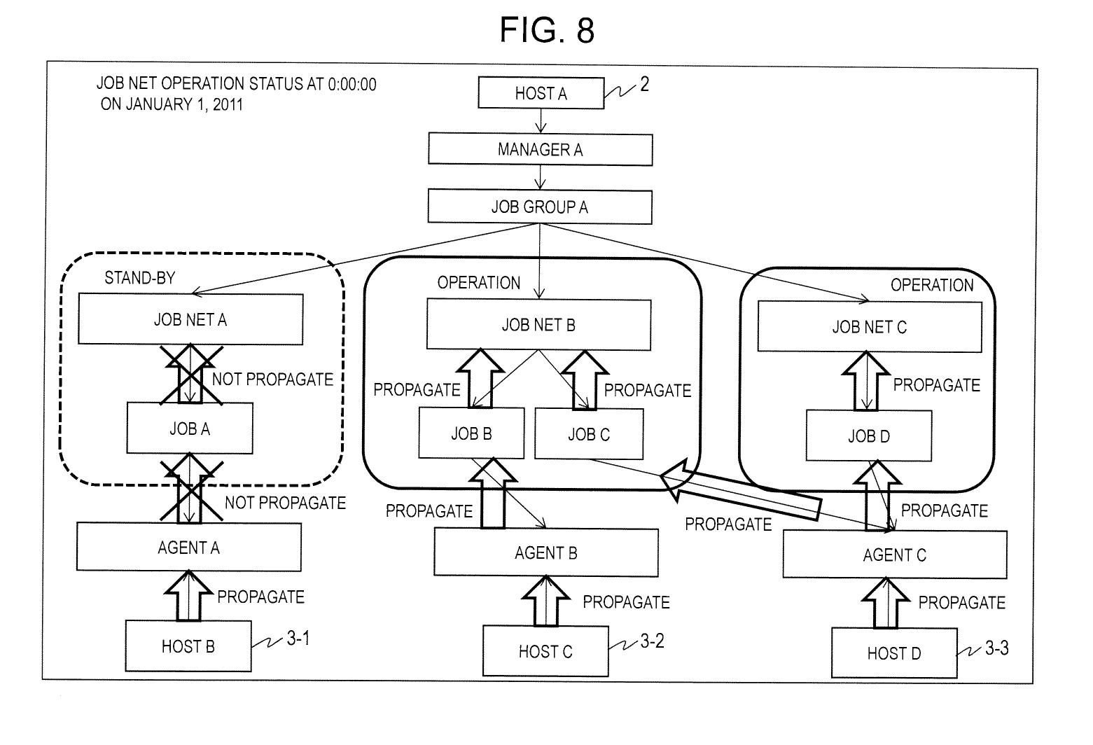

With the configuration management server 1 of the present invention, the influence can be analyzed every specified time interval as shown in FIG. 8 to FIG. 10 with reference to the schedule information 162 on 1:00:00 to 3:00:00 as depicted in FIG. 11. The details of the influence analysis are described later.

FIG. 8 depicts a window showing the results of analyzing the influence at the time 0:00:00 on Jan. 1, 2011. In this window on the output device 13, the influence analysis results are displayed by the configuration information display part 121 of the configuration management server 1, and the range of the influence from the stop of the hosts B to D is shown by thick arrows. The element of the configuration information with a mark of X on the thick arrow in the drawing is not influenced by the stop of the hosts. According to the schedule information 162, at the time of 0:00:00, the job net A is not in operation and the job nets B and C are in operation. Therefore, even though the host B is stopped, the job net A is not influenced (influence does not propagate to the job net A). Meanwhile, since the job nets B and C are in operation in the hosts C and D, the job nets B and C are influenced when the hosts C and D are stopped.

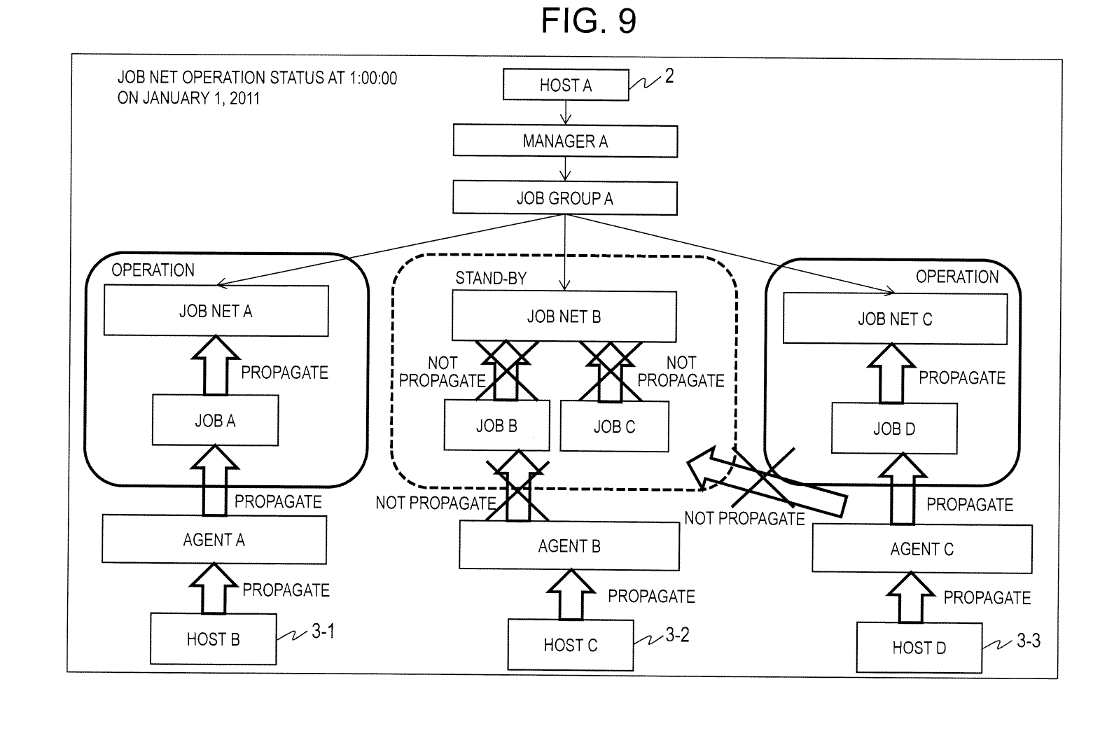

FIG. 9 depicts a window showing the results of analyzing the influence at the time 1:00:00 on Jan. 1, 2011. According to the schedule information 162, at the time of 1:00:00, the job net A is in operation, the job net B is not in operation, and the job net C is in operation. Therefore, even though the host C is stopped, the job net B is not influenced (influence does not propagate to the job net B). Meanwhile, since the job nets A and C are in operation in the hosts B and D, the job nets A and C are influenced when the hosts B and D are stopped.

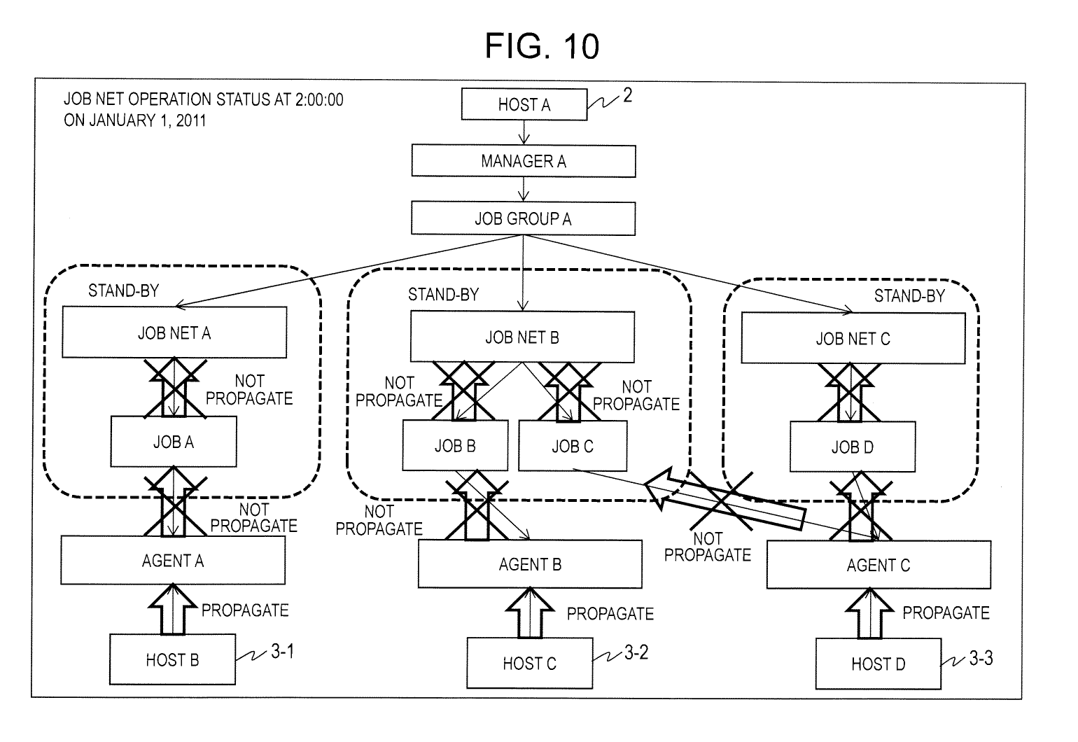

FIG. 10 depicts a window showing the results of analyzing the influence at the time 2:00:00 on Jan. 1, 2011. According to the schedule information 162, at the time of 2:00:00, all the job nets A to C are not in operation. Therefore, when the hosts B to D are stopped, the job nets are not influenced.

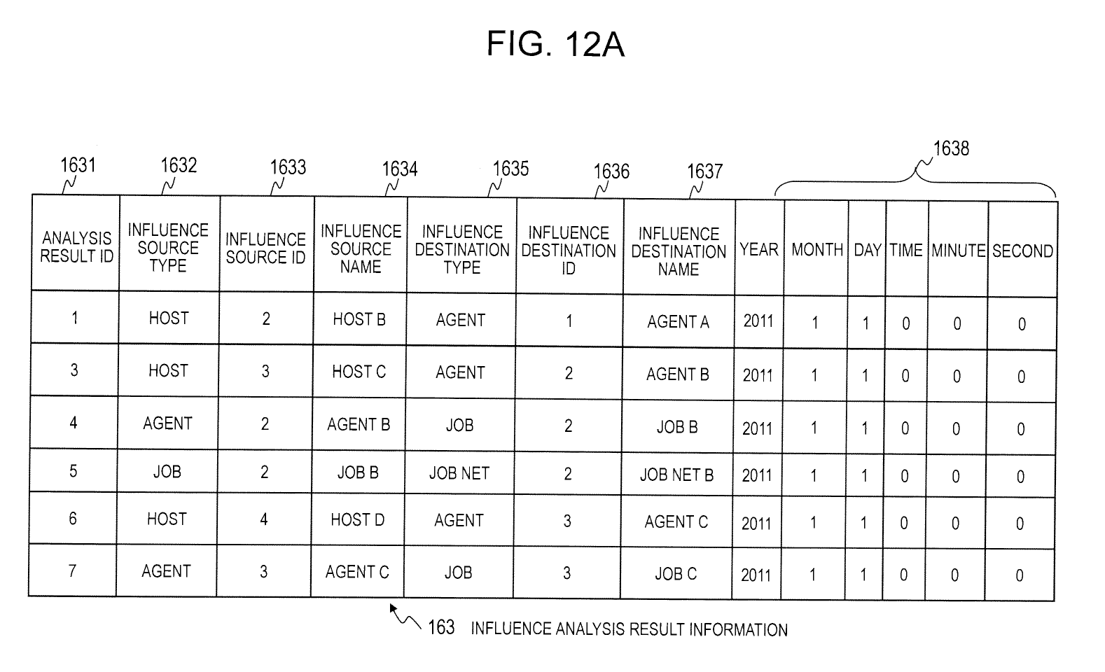

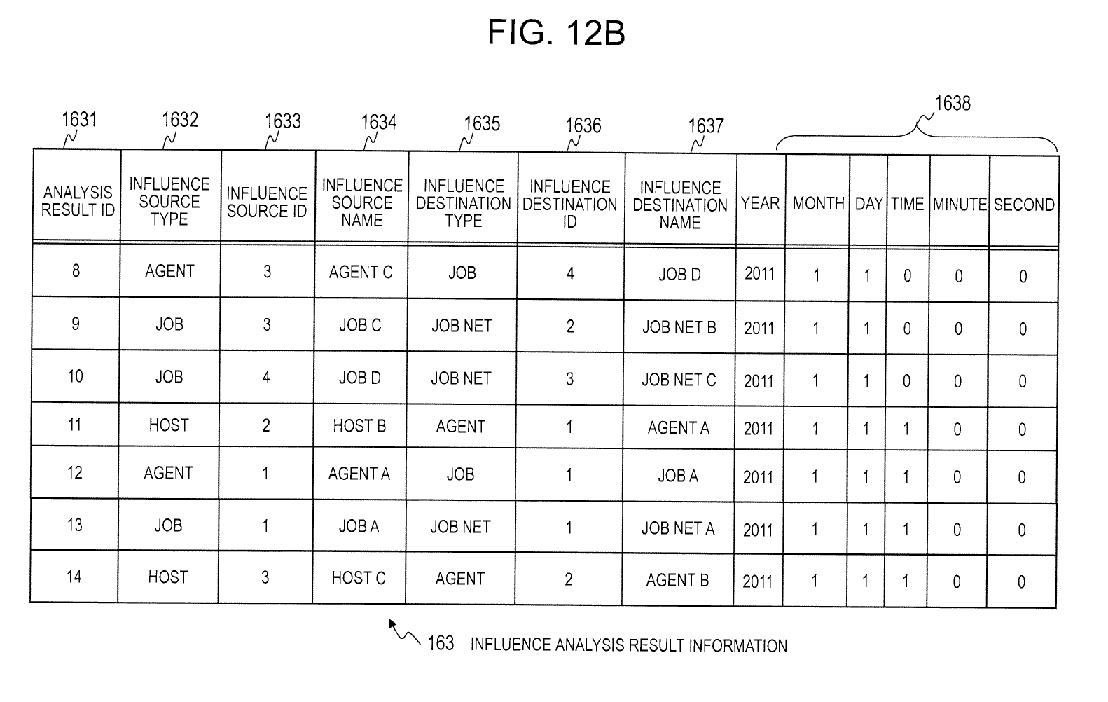

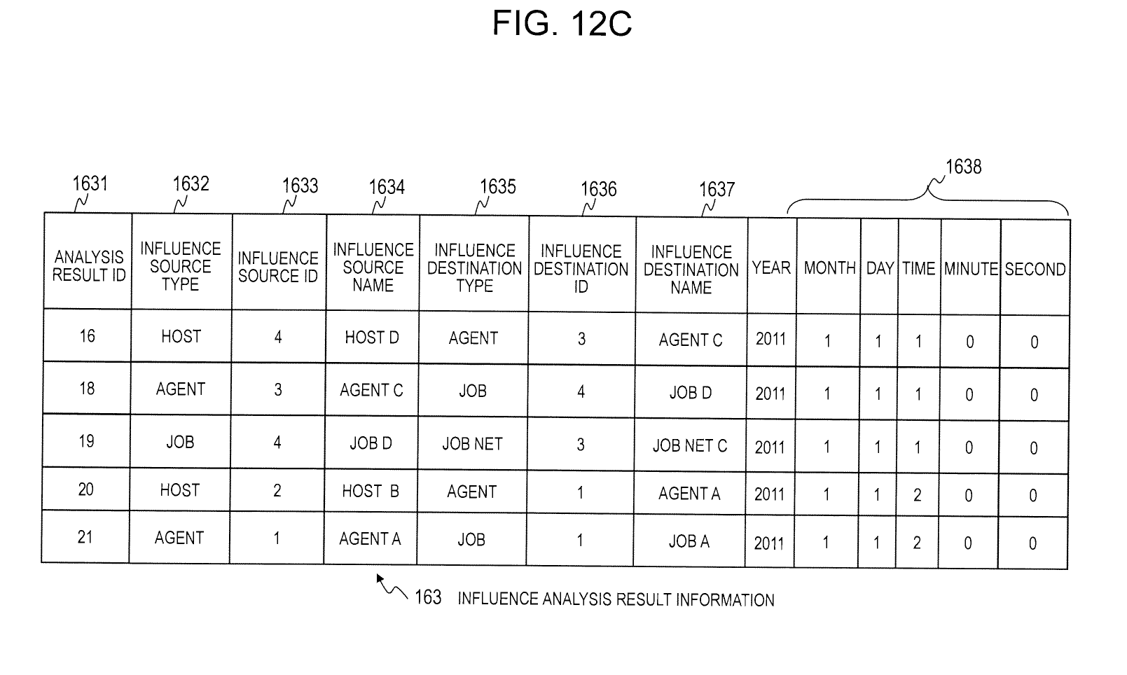

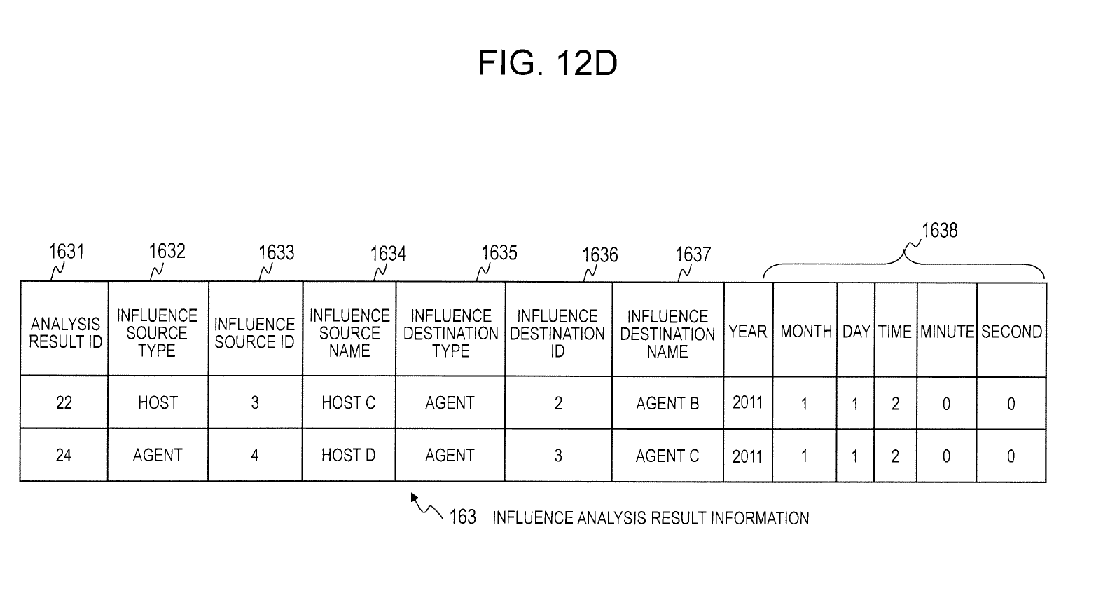

FIG. 12A to FIG. 12D are diagrams each depicting an example of the influence analysis result information 163 output by the influence analysis calculation part 125 in the case where the influence analysis is conducted in the time band shown in FIG. 11. One entry of the influence analysis result information 163 includes an analysis result ID 1631 storing the identifier of the analysis result, an influence source type 1632 storing the type of the configuration information that has the influence, an influence source ID 1633 storing the identifier of the configuration information that has the influence, an influence source name 1634 storing the name of the configuration information that has the influence, an influence destination type 1635 storing the type of the configuration information that is influenced, an influence destination ID 1636 storing the identifier of the configuration information that is influenced, an influence destination name 1637 storing the name of the configuration information that is influenced, and year, month, day, time, minute, and second 1638 of the analysis target.

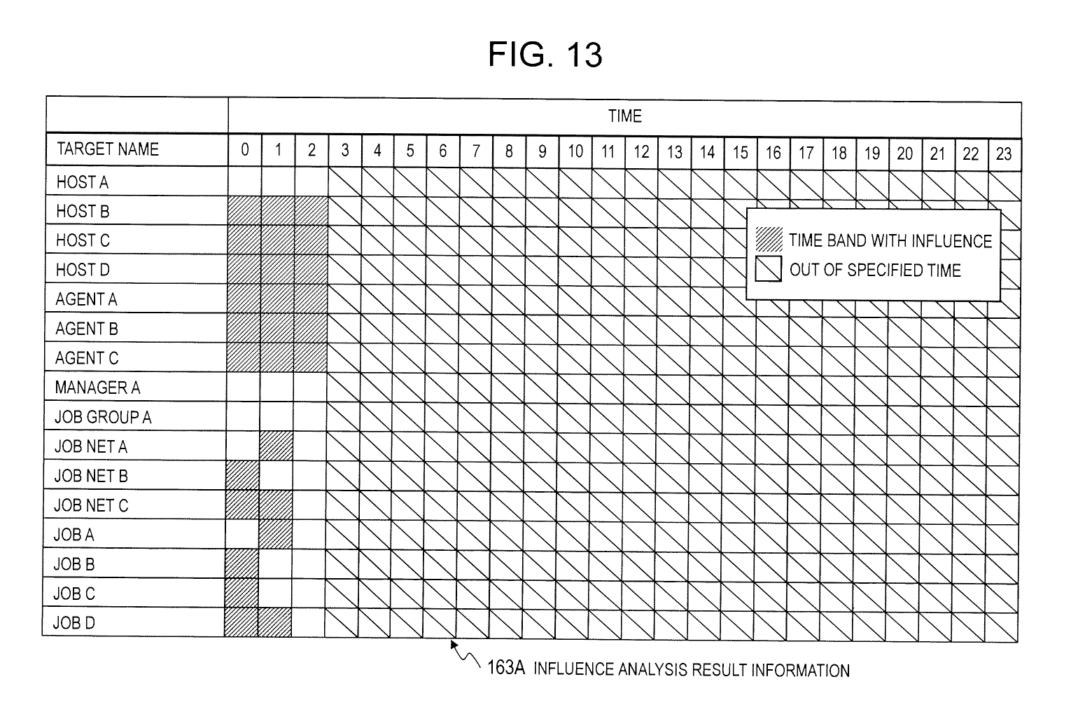

FIG. 13 depicts an example of influence analysis result information 163A in which the influence analysis calculation part 125 displays the presence or absence of the influence for each piece of configuration information on the output device 13 for each time band in accordance with the analysis results of FIG. 12A to FIG. 12D. The range of the job net and the job that are not influenced by the stop of the hosts B to D in the time band from 0:00 to 3:00 as the target of the influence analysis are displayed as a blank. The administrator of the job management system can easily and quickly ascertain the job net that is not influenced by the stop of the host by observing the influence analysis result information 163A. The administrator can easily ascertain the job nets A to C (i.e., jobs A to D) are not influenced by the stop of the hosts B to D in the time band from 2:00 to 2:59 in FIG. 13, for example.

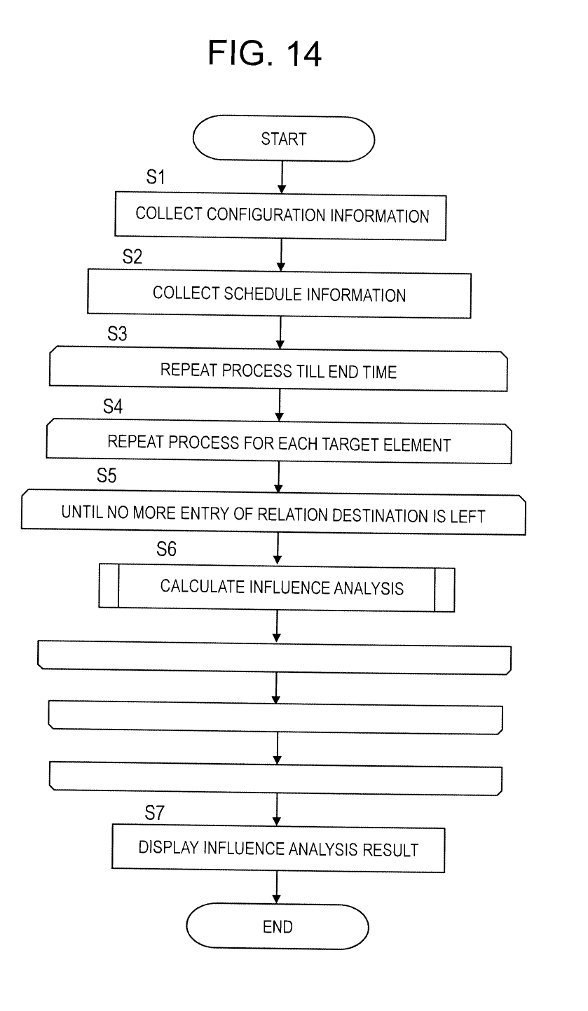

FIG. 14 is a flowchart for describing an example of the process performed in the configuration management server 1. This process is performed upon the reception of the order from the input device 14. The influence analysis calculation part 125 receives this order as a trigger of the execution when, for example, “OK” shown in FIG. 11 is operated.

The influence analysis calculation part 125 receives the start time, the end time, and the analysis time intervals together with the order of starting the execution from the window 1311 shown in FIG. 11. Then, in Step S1, the influence analysis calculation part 125 reads in the configuration information 161 (161-A to 161-G). In Step S2, the influence analysis calculation part 125 reads in the schedule information 162.

In Step S3, the influence analysis calculation part 125 repeats the process from Step S4 to Step S6 at the analysis time intervals from the received start time to end time.

In Step S4, the influence analysis calculation part 125 repeats the process of Step S5 and Step S6 until all the target elements of the configuration information 161-A to 161-F read in Step S1 are finished.

In Step S5, the influence analysis calculation part 125 repeats the process of Step S6 until all the entries of the configuration information 161-G read in Step S1 are finished (until no more relation destination is left).

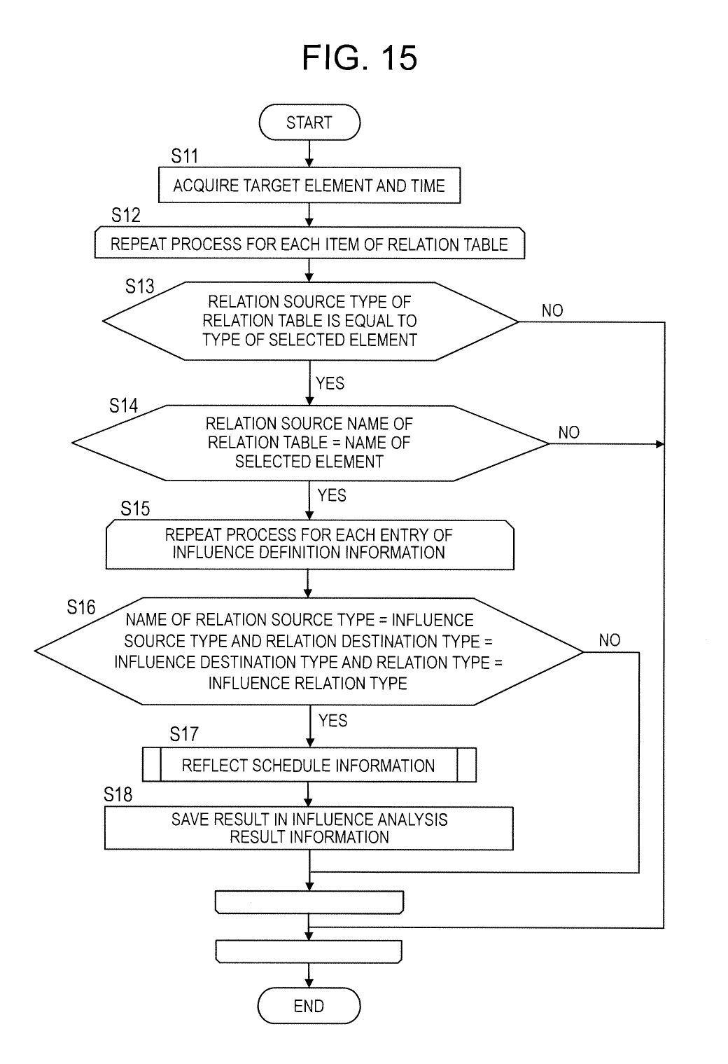

In Step S6, the influence analysis calculation part 125 executes the process in the flowchart of FIG. 15, thereby providing the influence analysis result information 163. Then, in Step S7, the influence analysis calculation part 125 displays the obtained influence analysis result information 163A as shown in FIG. 13.

FIG. 15 is a flowchart for describing an example of the process performed in Step S6 of FIG. 14. In Step S11, the influence analysis calculation part 125 advances the process to Step S12 with the element of the configuration information 161 read in Step S1 and at the time acquired in Step S3.

In Step S12, the processes of, and subsequent to Step S13 are repeated for each entry of the configuration information 161-G (relation table in the drawing) representing the relation of the elements.

In Step S13, the influence analysis calculation part 125 determines whether the type (161-A to 161-F) of the target element of the configuration information 161 currently acquired in Step S11 is equal to the relation source type 1602 of the entry of the configuration information 161-G which is currently focused. If the type of the target element of the configuration information 161 acquired in Step S11 is equal to the relation source type 1602 of the entry currently focused, the process advances to Step S14.

Meanwhile, if the target element of the configuration information 161 acquired in Step S11 is not equal to the relation source type 1602 of the entry currently focused, the process of FIG. 15 is finished and after the next entry of the configuration information 161-G or the element of the next configuration information 161 is acquired, the process of FIG. 15 is repeated.

In Step S14, the influence analysis calculation part 125 determines whether the element of the configuration information 161 acquired currently in Step S11 is equal to the relation source name 1604 of the entry of the configuration information 161-G currently focused. If the name of the element of the configuration information 161 acquired in Step S11 is equal to the relation source name 1604 of the entry currently focused, the process advances to Step S15.

Meanwhile, if the name of the element of the configuration information 161 acquired in Step S11 is not equal to the relation source name 1604 of the entry currently focused, the process of FIG. 15 is finished and after the next entry of the configuration information 161-G or the element of the next configuration information 161 is acquired, the process of FIG. 15 is repeated.

In Step S15, the influence analysis calculation part 125 repeats Step S16 for each entry of the influence definition information 166.

In Step S16, the influence analysis calculation part 125 determines whether or not: the relation source type 1602 of the element of the configuration information 161 currently acquired is equal to the influence source type 1662 of the entry of the influence definition information 166; the relation destination type 1605 of the element of the configuration information 161 is equal to the influence destination type 1663 of the entry of the influence definition information 166; and the relation type 1608 of the element of the configuration information 161 is equal to the influence relation type 1664 of the influence definition information 166.

If they are equal, the influence analysis calculation part 125 performs a schedule information reflection process in Step S17 and then, stores the calculation result in the influence analysis result information 163 in Step S18. Meanwhile, if the condition of Step S16 is not satisfied, the process is repeated in the next entry of the influence definition information 166.

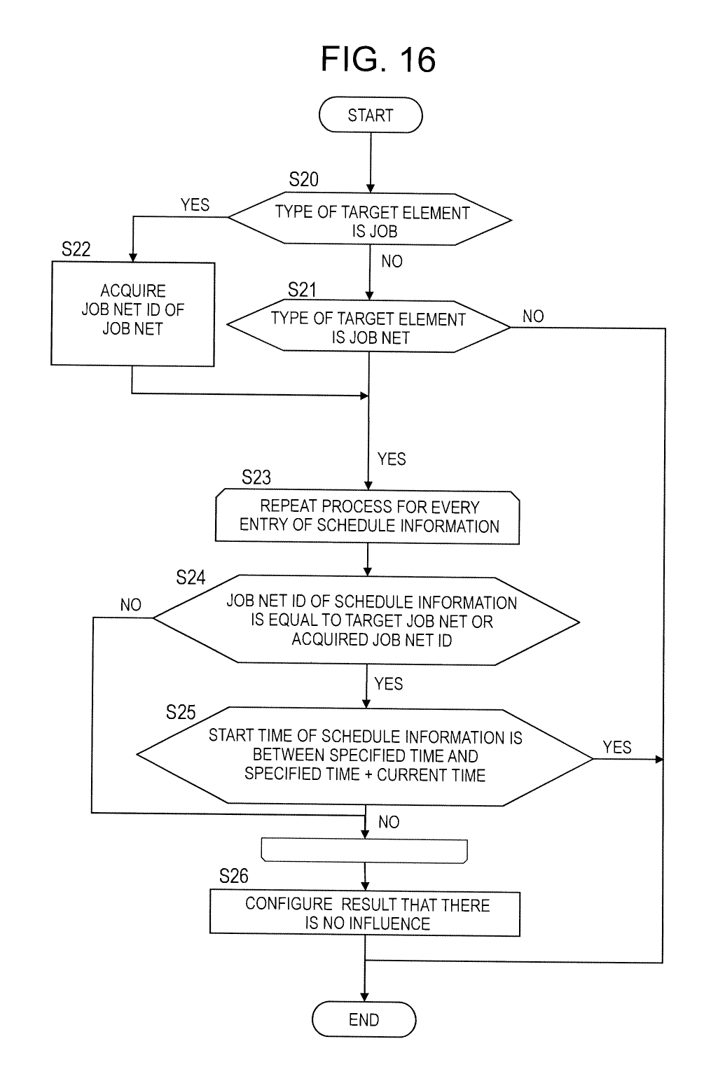

In Step S17, the process shown in FIG. 16 is performed. FIG. 16 is a flowchart depicting an example of the schedule information reflection process performed in Step S17 of FIG. 15.

In Step S20, the influence analysis calculation part 125 determines whether the type of the target element currently acquired is the job or not. If the type of the target element is determined as the job, the process advances to Step S22, and if not, the process advances to Step S21. In Step S22, the influence analysis calculation part 125 acquires the identifier of the job net to which the job as the target element belongs.

In Step S21, the influence analysis calculation part 125 determines whether the type of the target element currently acquired is the job net or not. If the type of the target element is the job net, the process advances to Step S23, and if not, the process returns to the process of FIG. 15 after the process of FIG. 16 is finished.

In Step S23, the influence analysis calculation part 125 repeats the process of Step S24 for every entry of the schedule information 162.

In Step S24, the influence analysis calculation part 125 determines whether the job net ID 1622 of the entry of the schedule information 162 currently focused is equal to the job net ID 1612 of the target element or to the job net ID acquired in Step S22. If the job net ID 1622 is equal to the job net ID 1612 of the target element or to the job net ID acquired, the influence analysis calculation part 125 advances the process to Step S25. Meanwhile, if the job net ID 1622 is not equal to the job net ID 1612 of the target element, the above process is repeated in the next entry of the schedule information 162.

In Step S25, the influence analysis calculation part 125 determines whether the start time 1624 to 1629 of the schedule information 166 is within the start time+interval of FIG. 11. If the time band from the start time 1624 to 1629 to a predetermined time (one hour in this embodiment) is within the start time+current interval (time in Step S11) of FIG. 11 as the analysis time, there is the influence from the stop of the hosts B to D; thus, the process of FIG. 16 is finished.

Meanwhile, if the time band from the start time 1624 to 1629 to the predetermined time is not within the start time+current interval (time in Step S11) of FIG. 11 as the analysis time, the job net is not influenced by the stop of the hosts B to D; thus, the process advances to Step S26 after the loop of Step S24 is completed at the end of the entry of the schedule information 162.

In Step S26, the influence analysis calculation part 125 finishes the process of FIG. 16 after configuring the information in which the job net ID is not influenced by the stop of the hosts B to D in the start time+current interval (time in Step S11), and returns to the process of FIG. 15.

In Step S18 of FIG. 15, in the case where the information in which the job net is not influenced by the stop of the hosts B to D is configured, the entry of the influence analysis result information 163 is not generated at the analysis time (start time+current interval (time of Step S11)). Moreover, the entry of the influence analysis result information 163 is not generated as for the job that belongs to the job net.

Meanwhile, in the other case (if there is the influence from the stop of the hosts B to D), the entry of the target element of the job net target element is added to the influence analysis result information 163 at the start time+current interval (time of Step S11).

In other words, the influence analysis calculation part 125 newly adds the entry in the influence analysis result information 163 of FIG. 12A to FIG. 12D, thereby configuring the new analysis ID 1631. Then, the influence analysis calculation part 125 acquires the type 1611, ID 1612, and name 1613 of the target element, and stores them in the influence destination type 1635, the influence destination ID 1636, and the influence destination name 1637 of the influence analysis result information 163, respectively. Moreover, with reference to the configuration information 161-G on the relation of the element, the influence analysis calculation part 125 acquires the relation source type 1602, the relation source ID 1603, and the relation source name 1604 of the target element, and then stores them in the influence source type 1632, the influence source ID 1633, and the influence source name 1634 of the influence analysis result information 163, respectively. Moreover, the influence analysis calculation part 125 generates one entry by storing the analysis time in the year, month, day, time, minute, and second 1638.

By repeating the above processes of Step S1 to Step S7, the target element influenced by the stop of the hosts B to D is specified at specified time intervals within the start time to the end time input in the time specifying window 1311 of FIG. 11, and the specified target element is added to the influence analysis result information 163. Meanwhile, the entry is not generated in the influence analysis result information 163 as for the job net and the job which are not influenced by the stop of the hosts B to D at specified time intervals.

Therefore, the influence analysis result information 163A shown in FIG. 13 is obtained as a result of displaying each entry of the influence analysis result information 163 at the analysis time intervals as shaded parts by the influence analysis calculation part 125 in Step S7 of FIG. 14. In the influence analysis result information 163A of FIG. 13, the target element without the entry is displayed as a blank part at the analysis time intervals and these blank parts can clearly indicate the range of the job for not stopping the hosts B to D.

Note that although the target element influenced by the stop of the hosts B to D is added to the influence analysis result information 163 in Step S18 of FIG. 15, the influence analysis result information 163 may have an item storing whether there is the influence from the stop of the host. In this case, as for the target element influenced by the stop of the hosts B to D, “1” is configured to the item storing whether there is the influence from the stop of the host and “0” is configured to the item in the case of the target element which is not influenced thereby. In this case, just the target element which is not influenced by the stop of the hosts B to D can be quickly searched from the influence analysis result information 163.

Thus, according to the present invention, it is possible to quickly and easily obtain the range of the influence on the job net (and the job) from the stop of the hosts (job execution servers 3) B to D in the time band of the analysis target under a circumstance in which the operation and non-operation of the businesses (job nets) provided by the hosts B to D change according to the time passage.

### <Release Plan>

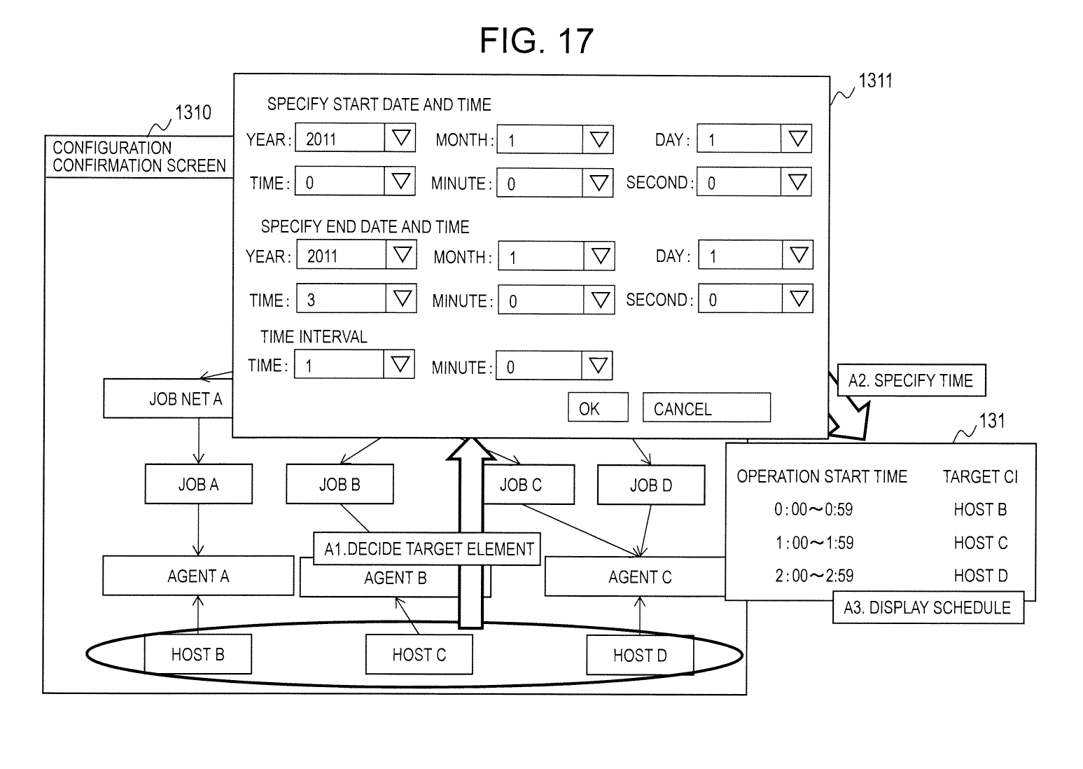

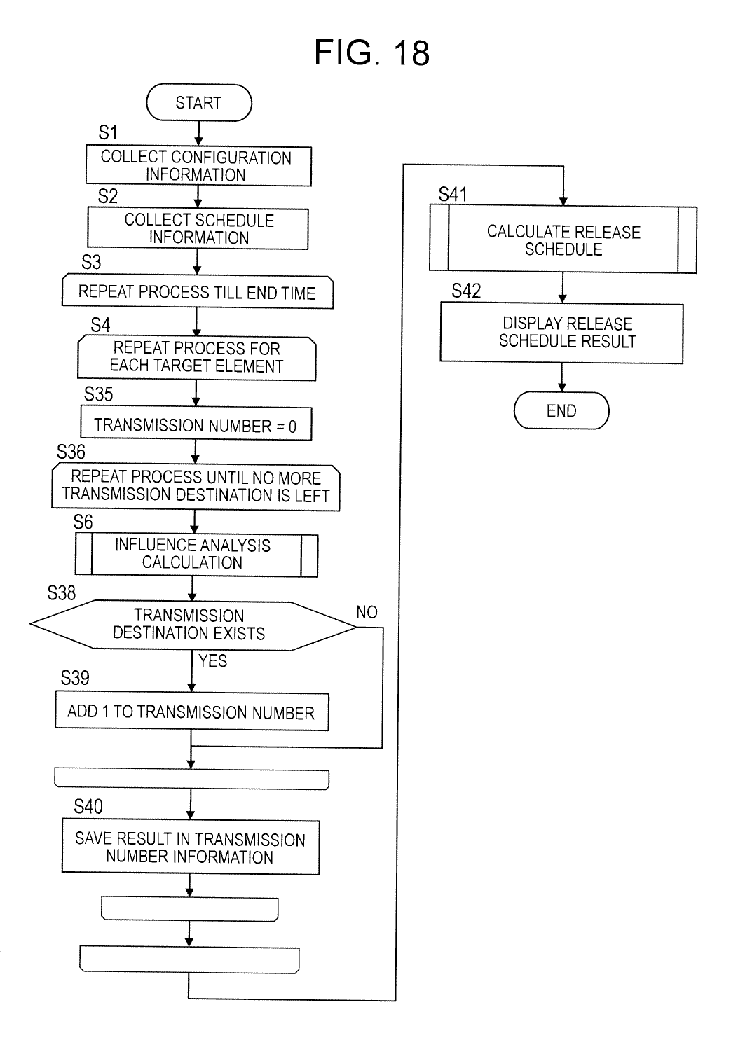

Next, the process performed by a release plan calculation part 122 of the configuration management server 1 is described. FIG. 17 is a diagram depicting the summary of the process performed by the release plan calculation part 122. The release plan calculation part 122 prepares the plan of stopping the job execution server 3 in the time band received from the input device 14 operated by the administrator or the like, and outputs the plan to the output device 13.

First, in the window 1310 of the configuration information shown in FIG. 5 displayed on the output device 13, the administrator or the like selects the target job execution server 3 (host) of the target (A1 in FIG. 17). In this example, the hosts B to D are selected and stopped for the maintenance or the like. Next, the time band and time interval (time for each host) for stopping the selected hosts B to D are configured in the time specifying window 1311 shown in FIG. 11 (A2 in FIG. 17). The configuration management server 1 causes the influence analysis calculation part 125 to calculate the time band in which the job net is not influenced, through the aforementioned process. Then, the release plan calculation part 122 configures the time band and the order capable of stopping the hosts and displays the time band and the order on a release plan window 1312 (A3 in FIG. 17). In the example of FIG. 17, in the execution of the maintenance of the hosts B to D, such a schedule is presented that the host B is stopped from 0:00 to 0:59, the host C is stopped from 1:00 to 1:59, and then the host D is stopped from 2:00 to 2:59. In the above example, the time required for activating the hosts B to D is omitted for simplifying the description; however, it is desirable to make a correction by subtracting the activation time of every host from the end time of the stop period in the calculation of the release plan.

FIG. 18 is a flowchart for describing one example of the release plan calculation process performed in the configuration management server 1. This process is executed after the release plan calculation part 122 selects the host of the release target in each of the windows 1310 and 1311 shown in FIG. 17 and acquires the time band where the release is scheduled. The release plan calculation part 122 first executes Steps S1 to S4 by activating the influence analysis calculation part 125 in a manner similar to FIG. 14. Note that the influence analysis result information 163 and the release plan result information 169 are cleared beforehand. In this embodiment, the target element is three hosts B to D.

In Step S35, the influence analysis calculation part 125 resets the transmission number to 0. The transmission number represents the number of target elements which are influenced by the stop of the hosts. The transmission number is reset to 0 for each target element and each analysis time.

In Step S36, the processes of Step S6 and S38 are repeated until there is no more influence destination of the target element left.

In Step S6, the influence analysis calculation part 125 configures the influence analysis result information 163 by determining whether or not the target element is influenced by the stop of the host on the basis of the schedule information 162 in a manner similar to FIG. 15.

In Step S38, the influence analysis calculation part 125 determines whether another element (transmission destination) to which the influence of the target element is transmitted exists or not. In other words, if the presence of the entry having the name of the current target element in the relation source name 1604 is determined with reference to the configuration information 161-G shown in FIG. 4G, the influence analysis calculation part 125 determines that the transmission destination exists.

If the transmission destination exists, the process advances to Step S39 and the influence analysis calculation part 125 adds 1 to the transmission number. After that, the loop process of Step S36 is repeated.

Meanwhile, if the transmission destination does not exist, the influence analysis calculation part 125 finishes the loop of Step S36 and the process advances to Step S40. In Step S40, the influence analysis calculation part 125 stores the transmission number of the target element in the transmission number information 164.

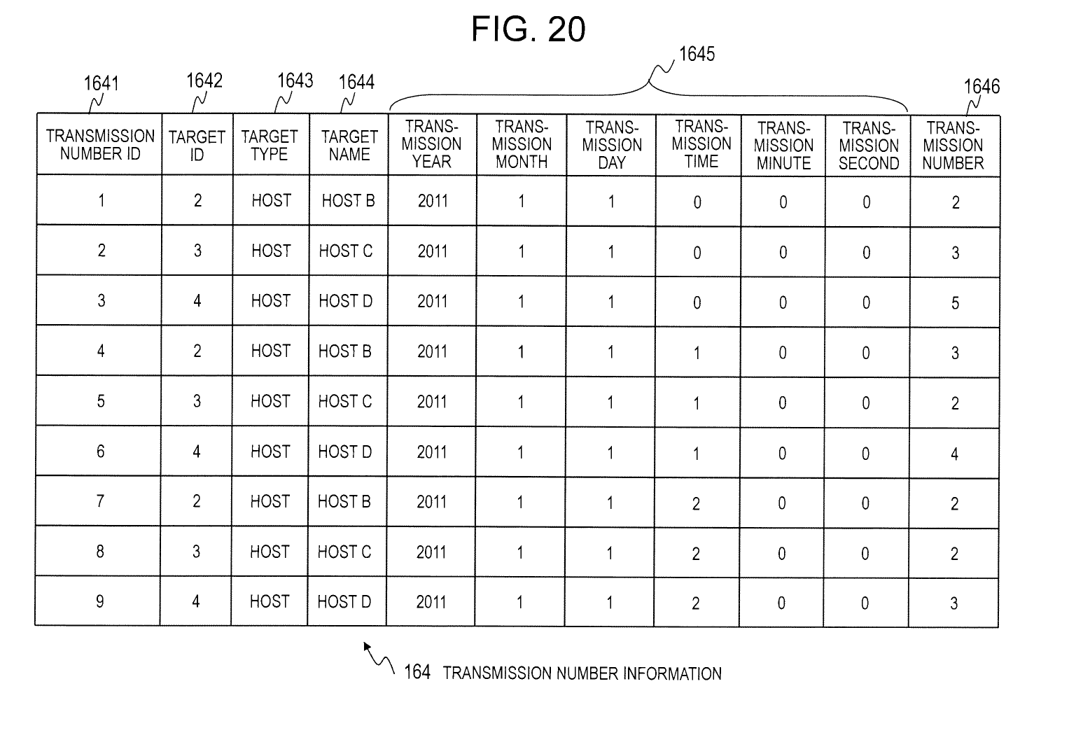

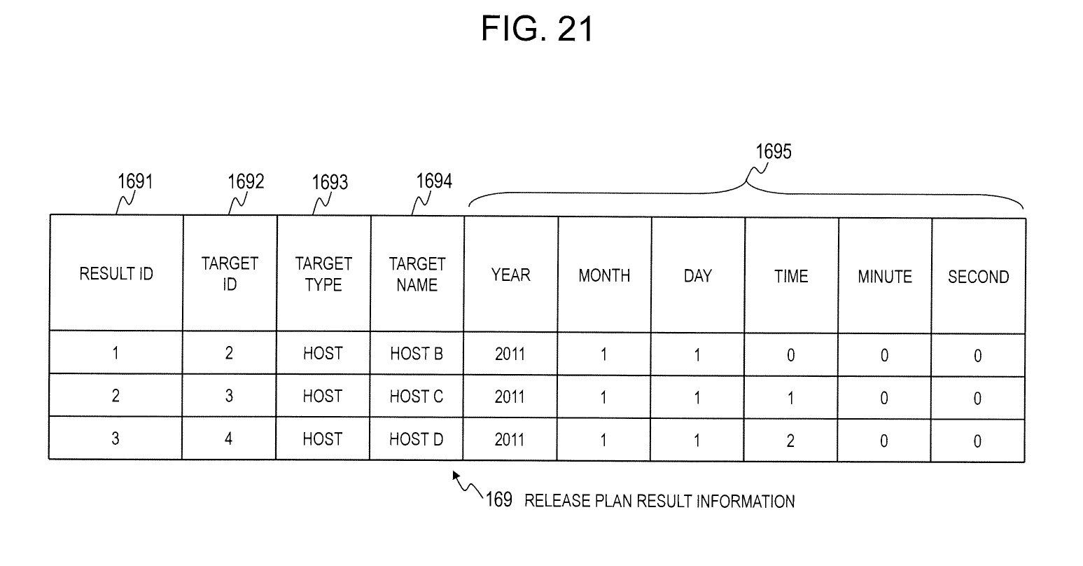

Here, the transmission number information 164 is a table as shown in FIG. 20. One entry of the transmission number information 164 includes: a transmission number ID 1641 storing the identifier determined by the influence analysis calculation part 125; a target ID 1642 storing the identifier of an element of the configuration information as the current target element in the configuration information 161; a target type 1643 storing the type of the element of the configuration information as the current target element; a target name 1644 storing the name of the element of the configuration information as the current target element; a transmission year, month, day, time, minute, and second 1645 storing the current analysis time as the transmission time; and a transmission number 1646.

The influence analysis calculation part 125 repeats the process for every target element of the configuration information 161 till the end time in a manner similar to FIG. 14. Upon the completion of the loop of Steps S3 and S4 of the influence analysis calculation part 125, the release plan calculation part 122 executes Step S41.

In Step S41, as later described, the release plan calculation part 122 calculates the release plan for every target element for the release plan result information 169 and stores the release plan in the release plan result information 169.

Then, in Step S42, the release plan calculation part 122 outputs the release plan result information 169 for each target element obtained as above to the output device 13.

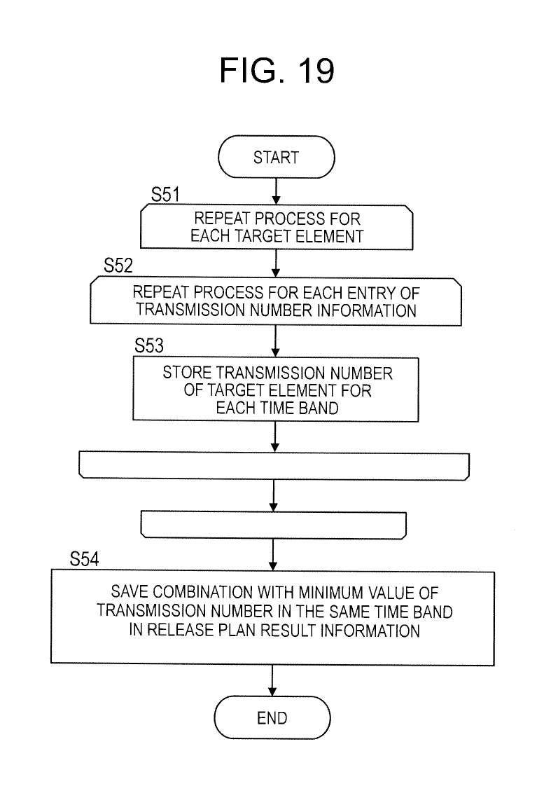

FIG. 19 is a flowchart for describing an example of the process of the release plan calculation part 122 performed in Step S41 of FIG. 18.

In Step S51, the release plan calculation part 122 repeats the processes of Steps S52 and S53 till the number of the target elements. Since the target elements are three of the hosts B to D in this embodiment, there are three loops.

In Step S52, the release plan calculation part 122 repeats the process of Step S53 till the number of entries of the transmission number information 164 of FIG. 20.

In Step S53, the release plan calculation part 122 stores the transmission number of each target element relative to the same time band with reference to the transmission number information 164. Upon the completion of the process of Step S53 on all the entries of the transmission number information 164, the process advances to Step S54.

In Step S54, the transmission numbers of the target elements are compared for every time band stored in Step S53 and the target element with the smallest transmission number is added to the release plan result information 169. However, the release plan calculation part 122 removes the target element, which has already been added to the release plan result information 169, from the comparison target in the subsequent time bands.

FIG. 21 is a diagram depicting an example of the release plan result information 169. One entry of the release plan result information 169 includes a result ID 1691 storing the identifier of the release plan determined by the release plan calculation part 122, a target ID 1692 storing the identifier of the target element, a target type 1693 storing the type of the target element, a target name 1694 storing the name of the target element, and a year, month, day, time, minute, and second 1695 storing the release start time.

In Step S54, the release plan calculation part 122 first compares the transmission numbers between the target elements (hosts B to D) when the transmission time of the transmission year, month, day, time, minute, and second 1645 as the first time band is 0:00. When the transmission time is 0:00, the transmission number of the host B is 2, which is the smallest. The release plan calculation part 122 adds the host B to the entry while the transmission time 0:00 is assumed as the release start time and the result ID of the release plan result information 169 is assumed as 1.

The release plan calculation part 122 compares the transmission numbers between the target elements (hosts C and D) when the transmission time of the transmission year, month, day, time, minute, and second 1645 as the next time band is 1:00. As for the host B, since it is configured in the release plan result information 169 in the first time band, the host B is removed from the comparison targets in the subsequent time bands. When the transmission time is 1:00, the transmission number of the host C is 2, which is the smallest. The release plan calculation part 122 adds the host C to the entry while the transmission time 1:00 is assumed as the release start time and the result ID of the release plan result information 169 is assumed as 2.

The release plan calculation part 122 compares the transmission numbers of the target element (host D) when the transmission time of the transmission year, month, day, time, minute, and second 1645 as the final time band is 2:00. As for the hosts B and C, since they are configured in the release plan result information 169 in the precedent time bands, the hosts B and C are removed from the comparison targets in the subsequent time bands. When the transmission time is 2:00, the transmission number of the host D is 3, which is the smallest. The release plan calculation part 122 adds the host D to the entry while the transmission time 2:00 is assumed as the release start time and the result ID of the release plan result information 169 is assumed as 3.

Through the above process, the release plan result information 169 is generated and the content of FIG. 21 is output to the output device 13 as the release plan result.

As thus described, the release plan calculation part 122 can quickly and safely plan the host (job execution server 3) to be stopped in a desired time band using the influence analysis calculation part 125, thereby drastically reducing the labor of the administrator.

### Second Embodiment

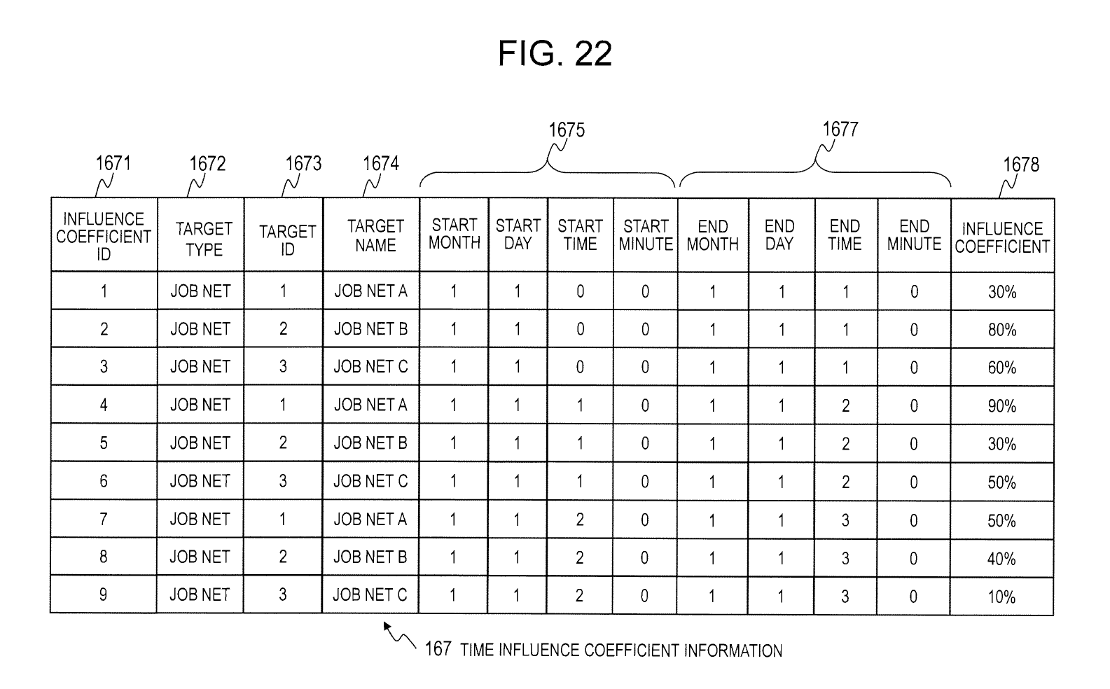

FIG. 22 to FIG. 28 depict a second embodiment of the present invention. In the second embodiment, the influence analysis when the host is stopped is conducted in consideration of the influence on the businesses provided by the job nets A to C. In other words, in the first embodiment, the presence or absence of the influence on the job net for each time band from the stop of the host is analyzed based on the schedule information 162. In contrast, in the second embodiment, the influence coefficient of the job net for each time band when the host is stopped is analyzed based on time influence coefficient information 167. The other points are similar to those of the first embodiment.

The influence on the business from the stop of the host executing the job is defined in the time influence coefficient information as the influence coefficient on the business of a client as a business impact, and the influence coefficient varying depending on the time band is configured in advance for each business. In this embodiment, the business impact for each time band on the job nets A to C representing the businesses is defined as the influence coefficient. This influence coefficient represents the range of the business that is influenced by the stop of the host. For example, if the influence coefficient is 100%, the businesses provided by the job nets entirely stop. Alternatively, the influence coefficient may represent the ratio of the number of users influenced by the stop of the host.

The influence coefficient represented by the business impact may be the influence coefficient on the job net for each time defined by a user or the administrator, for example. For example, the definition may be that the influence on the business (job net) operating for 24 hours is small in the morning (for example, approximately 30%) and large in the afternoon (approximately 80%).

FIG. 22 is a diagram depicting an example of the time influence coefficient information 167. One entry of the time influence coefficient information 167 includes an influence coefficient ID 1671 storing the identifier of the influence coefficient, a target type 1672 storing the type of the configuration information that has the influence, a target ID 1673 storing the identifier of the configuration information that is influenced, a target name 1674 storing the name of the configuration information that is influenced, a start time 1675 storing the start time (month, day, time, and minute) of the time influence coefficient, an end time 1677 storing the end time (month, day, time, and minute) of the time influence coefficient, and an influence coefficient 1678 storing the influence coefficient in a time band from the start time 1675 to the end time 1677. Note that the influence coefficient on each job net for each time band is preconfigured by the administrator or the like.

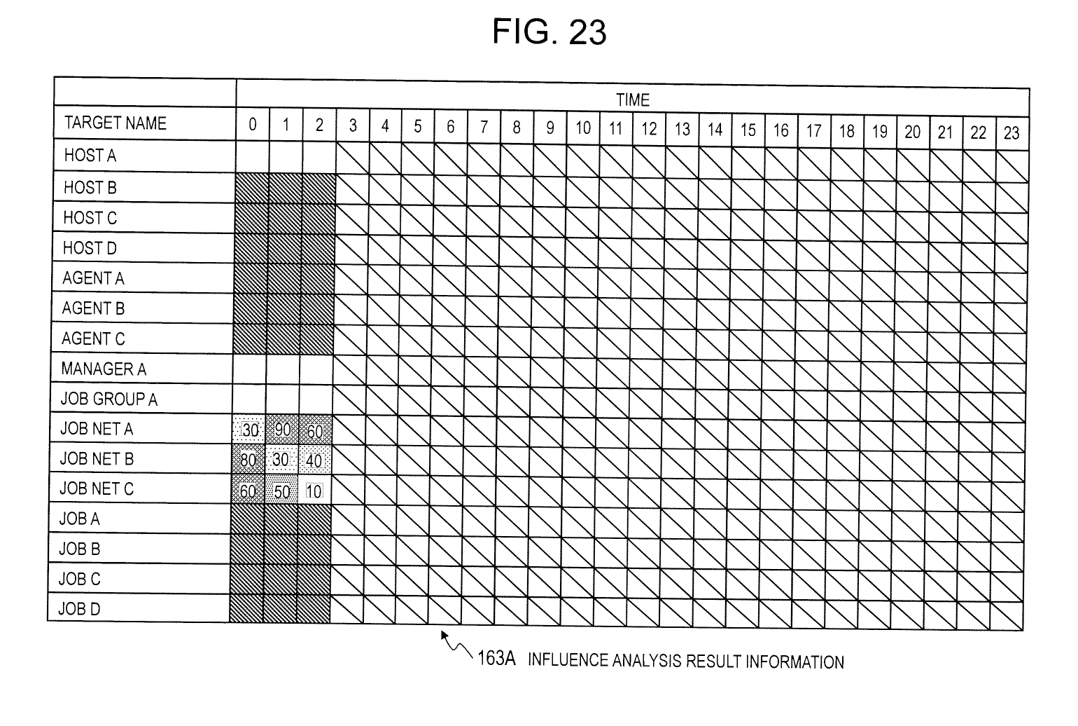

FIG. 23 depicts an example of the influence analysis result information 163A representing the influence coefficient displayed on the output device 13, obtained as a result of calculating the influence of each piece of configuration information for each time band by the influence analysis calculation part 125 in a manner similar to the first embodiment. The influence coefficient in the case of stopping the hosts B to D in the time band from 0:00 to 3:00 as the analysis target for which the time influence coefficient is configured is displayed for each job net. The influence coefficient may be displayed by the numerals and the patterns combined as depicted, or may alternatively be displayed by the color or the pattern changed depending on the magnitude of the influence coefficient.

The administrator of the job management system can easily and quickly ascertain the influence coefficient in the case of stopping the hosts by observing the influence analysis result information 163A on the basis of the changes in numerals, patterns, etc. The administrator can easily ascertain the influence coefficient on the job net A is 60% while the influence coefficient on the job net C is 10% when the hosts B to D are stopped in the time band from 2:00 to 2:59 in FIG. 23, for example.

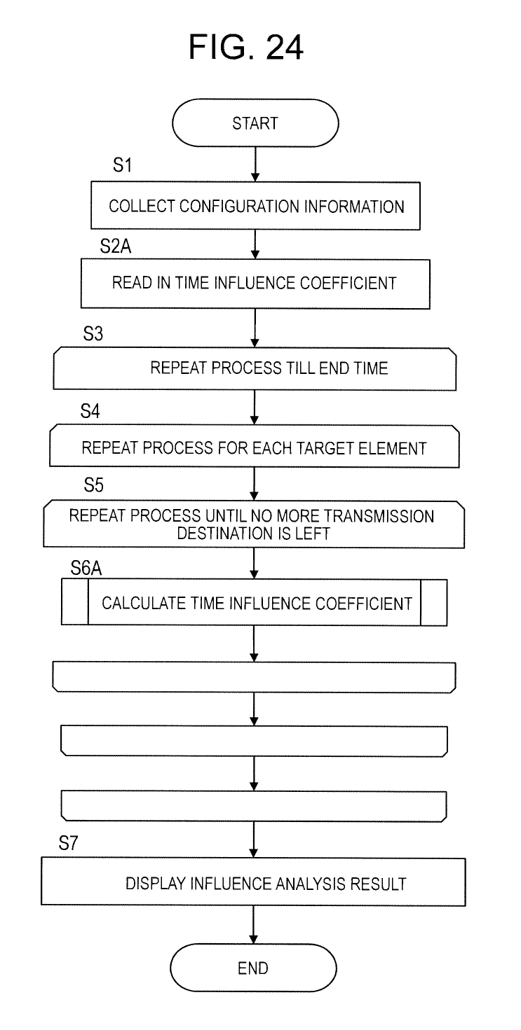

FIG. 24 is a flowchart for describing an example of the influence analysis process performed in the influence analysis calculation part 125. The difference from the influence analysis process described in the first embodiment with reference to FIG. 14 is as follows: in the first embodiment, the schedule information 162 is read in Step S2; on the other hand, in the second embodiment, the time influence coefficient information 167 is read in Step S2A and the influence coefficient is added to the influence analysis result information 163 in Step S6A. The other points of the second embodiment are similar to those of the first embodiment.

The influence analysis calculation part 125 receives the start time, the end time, and the analysis time intervals along with the order of starting the execution from the window 1311 depicted in FIG. 11. In Step S1, the influence analysis calculation part 125 reads in the configuration information 161 (161-A to 161-G). In Step S2A, the time influence coefficient information 167 is read in.

In Step S3, the influence analysis calculation part 125 repeats the processes of Step S4 to Step S6 at analysis time intervals from the received start time to end time.

In Step S4, the influence analysis calculation part 125 repeats the processes of Step S5 and Step S6 until all the target elements of the configuration information 161-A to 161-F read in Step S1 are finished.

In Step S5, the influence analysis calculation part 125 repeats the process of Step S6 until all the entries of the configuration information 161-G read in Step S1 are finished (until no more relation destination is left).

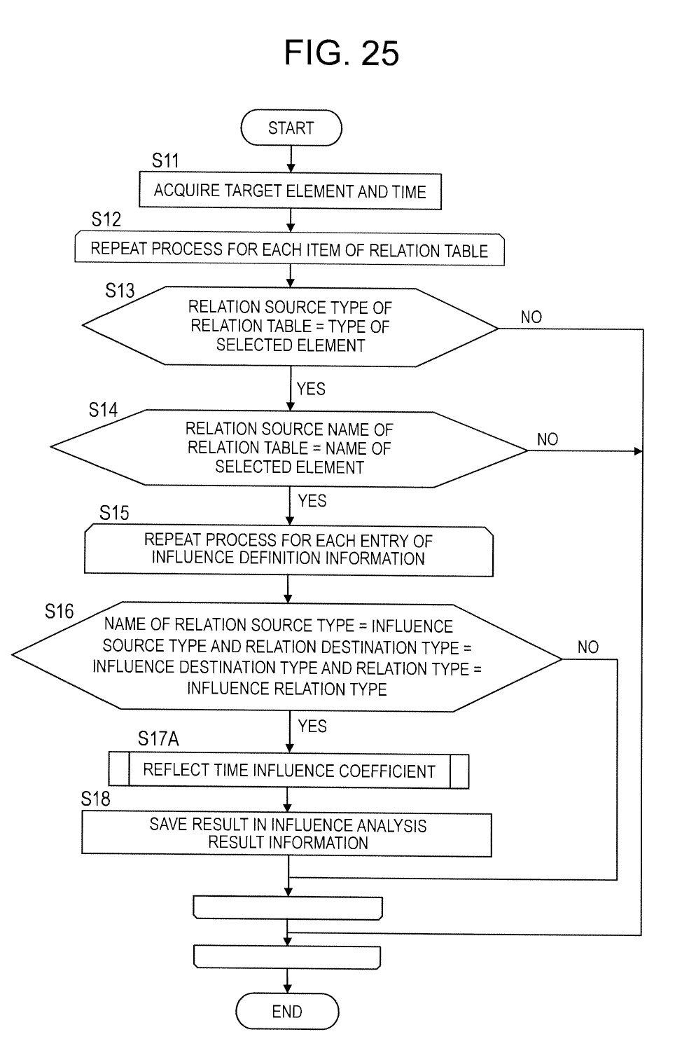

In Step S6A, the influence analysis calculation part 125 obtains the influence analysis result information 163 including the influence coefficient of each time band by executing the flowchart depicted in FIG. 25. In Step S7, the influence analysis calculation part 125 outputs the obtained influence analysis result information 163A to the output device 13 as depicted in FIG. 23.

FIG. 25 is a flowchart for describing an example of the process performed in Step S6A of FIG. 24. The process of FIG. 25 is similar to that of the first embodiment except that Step S17 in the process depicted in FIG. 15 of the first embodiment is replaced by Step S17A in which the time influence coefficient information 167 is reflected instead of the schedule information 162.

In Step S11, the process of the influence analysis calculation part 125 advances to Step S12 with the element of the configuration information 161 read in Step S1 of FIG. 24 and at the time acquired in Step S3 of FIG. 24, and in a manner similar to the first embodiment, the processes of, and subsequent to Step S13 are repeated on each entry of the configuration information 161-G (relation table in the drawing) representing the relation among the elements.

In Step S13, the influence analysis calculation part 125 determines whether the type (161-A to -F) of the target element of the configuration information 161 currently acquired in Step S11 is equal to the relation source type 1602 of the entry of the configuration information 161-G currently focused. If the type of the target element of the configuration information 161 acquired in Step S11 is equal to the relation source type 1602 of the entry currently focused, the process advances to Step S14.

Meanwhile, if the target element of the configuration information 161 acquired in Step S11 is not equal to the relation source type 1602 of the entry currently focused, the process of FIG. 25 is finished and after the next entry of the configuration information 161-G or the element of the next configuration information 161 is acquired, the process of FIG. 15 is repeated.

In Step S14, the influence analysis calculation part 125 determines whether the element of the configuration information 161 acquired currently in Step S11 is equal to the relation source name 1604 of the entry of the configuration information 161-G currently focused. If the name of the element of the configuration information 161 acquired in Step S11 is equal to the relation source name 1604 of the entry currently focused, the process advances to Step S15.

Meanwhile, if the name of the element of the configuration information 161 acquired in Step S11 is not equal to the relation source name 1604 of the entry currently focused, the process of FIG. 15 is finished and after the next entry of the configuration information 161-G or the element of the next configuration information 161 is acquired, the process of FIG. 15 is repeated.

In Step S15, the influence analysis calculation part 125 repeats the process of Step S16 for each entry of the influence definition information 166.

In Step S16, the influence analysis calculation part 125 determines whether or not: the relation source type 1602 of the element of the configuration information 161 currently acquired is equal to the influence source type 1662 of the entry of the influence definition information 166; the relation destination type 1605 of the element of the configuration information 161 is equal to the influence destination type 1663 of the entry of the influence definition information 166; and the relation type 1608 of the element of the configuration information 161 is equal to the influence relation type 1664 of the influence definition information 166.

If these are equal, the influence analysis calculation part 125 performs the schedule information reflection process of Step S17 and then stores the calculation result in the influence analysis result information 163 in Step S18. Meanwhile, if the condition of Step S16 is not satisfied, the process is repeated in the next entry of the influence definition information 166.

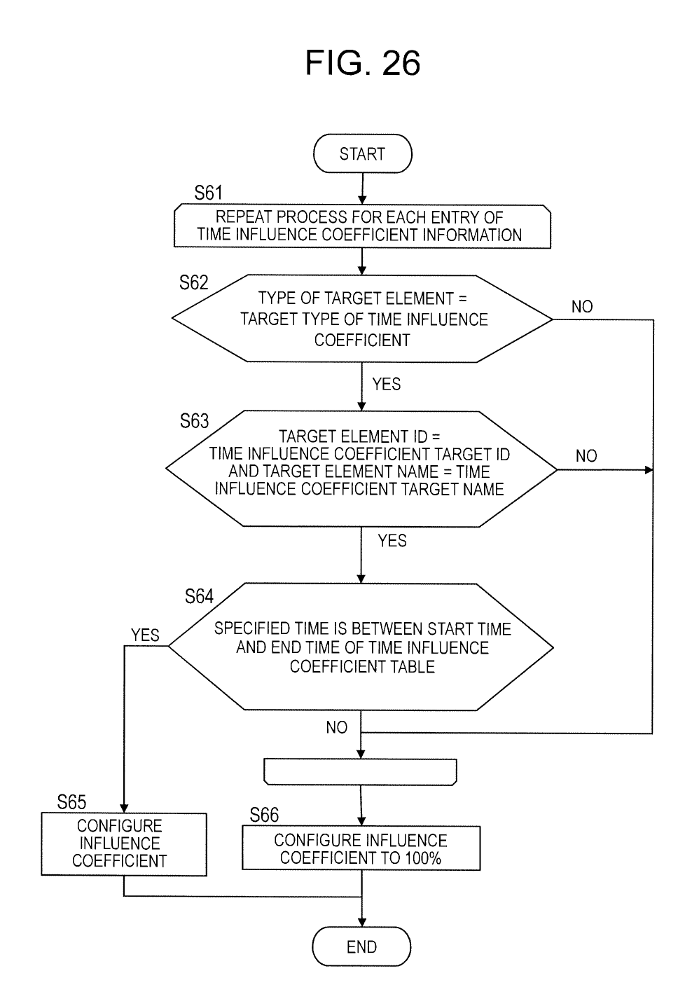

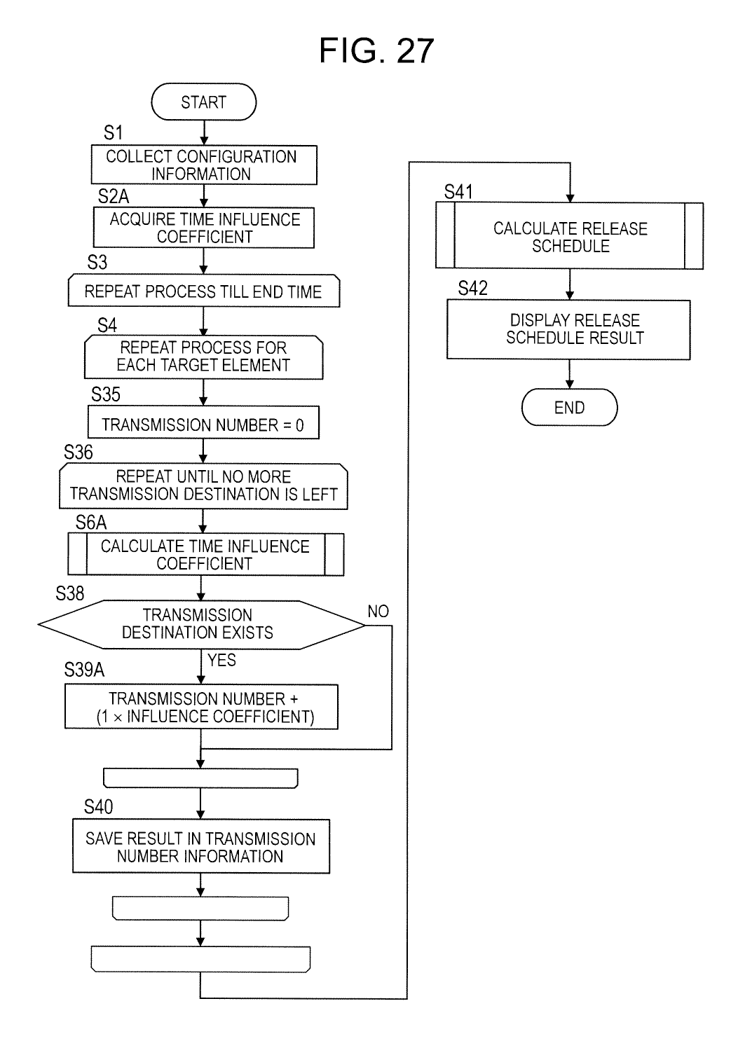

In Step S17A, the process depicted in FIG. 26 is executed. FIG. 26 is a flowchart for describing an example of the process performed in Step S17A of FIG. 25.

In Step S61 of FIG. 26, the influence analysis calculation part 125 repeats the processes of, and subsequent to Step S62 for each entry of the time influence coefficient information 167.

In Step S62, the influence analysis calculation part 125 determines whether the type of the target element currently acquired is equal to the target type 1672 of the entry of the time influence coefficient information 167 currently focused. If the type of the target element is equal to the target type 1672 of the time influence coefficient information 167, the process advances to Step S63 and if not, the process advances to the next entry of the time influence coefficient information 167 and the process of Step S62 is repeated.

In Step S63, the influence analysis calculation part 125 determines whether the target ID 1672 of the entry of the time influence coefficient information 167 currently focused is equal to the job net ID 1612 of the target element. If the target ID 1672 is equal to the job net ID 1612 of the target element, the influence analysis calculation part 125 advances the process to Step S64. Meanwhile, if the target ID 1672 is not equal to the job net ID 1612 of the target element, the above process is repeated in the next entry of the time influence coefficient information 167.

In Step S64, the influence analysis calculation part 125 determines whether the start time+interval time of FIG. 11 is within the time from the start time 1675 to the end time 1677 of the time influence coefficient information 167. If the start time+interval time of FIG. 11 is within the time band from the start time 1675 to the end time 1677 of the time influence coefficient information 167, there is the influence from the stop of the hosts B to D; therefore, the process advances to Step S65 and the influence coefficient 1678 of the time influence coefficient information 167 is acquired. Then, in Step S65, the influence analysis calculation part 125 configures the acquired influence coefficient 1678 in the analysis result of the target element (job net) currently acquired.

Meanwhile, if the start time+interval time of FIG. 11 is not within the time from the start time 1675 to the end time 1677 of the time influence coefficient information 167, the process moves on to the next entry of the time influence coefficient information 167, and upon the completion of all the entries, the process advances to Step S66. In Step S66, the target element currently acquired is influenced by the stop of the hosts B to D and no entries exist in the time influence coefficient information 167; thus, the influence coefficient of the target element is configured to 100%.

After the processes of FIG. 26, the process returns to FIG. 15.

In Step S18 of FIG. 15, if the influence coefficient of the job net in the case of stopping the hosts B to D is configured, the entry at the analysis time (start time+current time interval (time of Step S11)) is generated in the influence analysis result information 163. In this embodiment, the field of the influence coefficient may be added to the influence analysis result information 163 described in the first embodiment.

By repeating the processes of Steps S1 to S7 as above, the target element influenced by the stop of the hosts B to D is specified at specified time intervals in the range of the start time to the end time input from the time specifying window 1311 of FIG. 11, and the influence coefficient 1678 (or 100%) is added to the influence analysis result information 163. Meanwhile, as for the elements not influenced by the stop of the hosts B to D at specified time intervals, the entries are not generated in the influence analysis result information 163.

Therefore, as a result of displaying each entry of the influence analysis result information 163 by the influence analysis calculation part 125 at the analysis time intervals as a shaded part in Step S7 of FIG. 24, the influence analysis result information 163A depicted in FIG. 23 is obtained. In the influence analysis result information 163A of FIG. 23, the influence coefficient 1678 on the job net configured in the time influence coefficient information 167 is displayed in the corresponding time band.

As thus described, according to the second embodiment, it is possible to quickly and easily obtain the influence coefficient 1678 configured in the time influence coefficient information 167 given to the job net by the stop of the hosts B to D in the analysis target time band.

FIG. 27 depicts the process of automatically generating a release plan of the host (job execution server 3) by using the impact analysis made in consideration of the time influence coefficient. The process is similar to that of the first embodiment except that the schedule information 162 of the release plan generation process described in the first embodiment with reference to FIG. 18 is replaced by the time influence coefficient information 167 and that the time influence coefficient is multiplied by the transmission number information 164.

After the influence analysis result information 163 and the release plan result information 169 are cleared, the processes of Steps S1, S3, and S4 are executed in a manner similar to FIG. 14 of the first embodiment. In Step S2A, the release plan calculation part 122 reads in the time influence coefficient information 167 instead of the schedule information 162 of Step S2 of the first embodiment.

In Step S3, the influence analysis calculation part 125 invoked by the release plan calculation part 122 repeats the loop of, and subsequent to Step S4 at a preconfigured time interval (time specifying window 1311) until the end time 1677 of the entry of the time influence coefficient information 167.

In Step S4, the influence analysis calculation part 125 invoked by the release plan calculation part 122 repeats the loop of, and subsequent to Step S35 for each target element selected from the configuration information 161.

In Step S35, the influence analysis calculation part 125 invoked by the release plan calculation part 122 resets the transmission number to 0. The transmission number represents the number of target elements that are influenced by the stop of the host. The transmission number is reset to 0 for each target element and for each analysis time.

In Step S36, the process of Step S6A is repeated until no more transmission destination of the target element is left.

In Step S6A, the influence analysis calculation part 125 performs the process in a manner similar to FIG. 25 and FIG. 26 as above, and configures the influence analysis result information 163 by determining whether the target element is influenced by the stop of the host on the basis of the time influence coefficient information 167 instead of the schedule information 162.

In Step S38, the influence analysis calculation part 125 determines whether another element (transmission destination) to which the influence of the target element is transmitted exists or not. In other words, the influence analysis calculation part 125 determines that the transmission destination exists if there is the entry having the name of the current target element in the relation source name 1604 with reference to the configuration information 161-G depicted in FIG. 4G.

If the transmission destination exists, the process advances to Step S39A and the influence analysis calculation part 125 reads in the influence coefficient 1678 configured in the time influence coefficient information 167 and adds the influence coefficient 1678 to the transmission number calculated as follows:

transmission number=transmission number+(1×influence coefficient).

After that, the loop process of Step S36 is repeated.

Meanwhile, if the transmission destination does not exist, the influence analysis calculation part 125 finishes the loop of Step S36 and the process advances to Step S40. In Step S40, the influence analysis calculation part 125 stores the transmission number of the target element in the transmission number information 164.

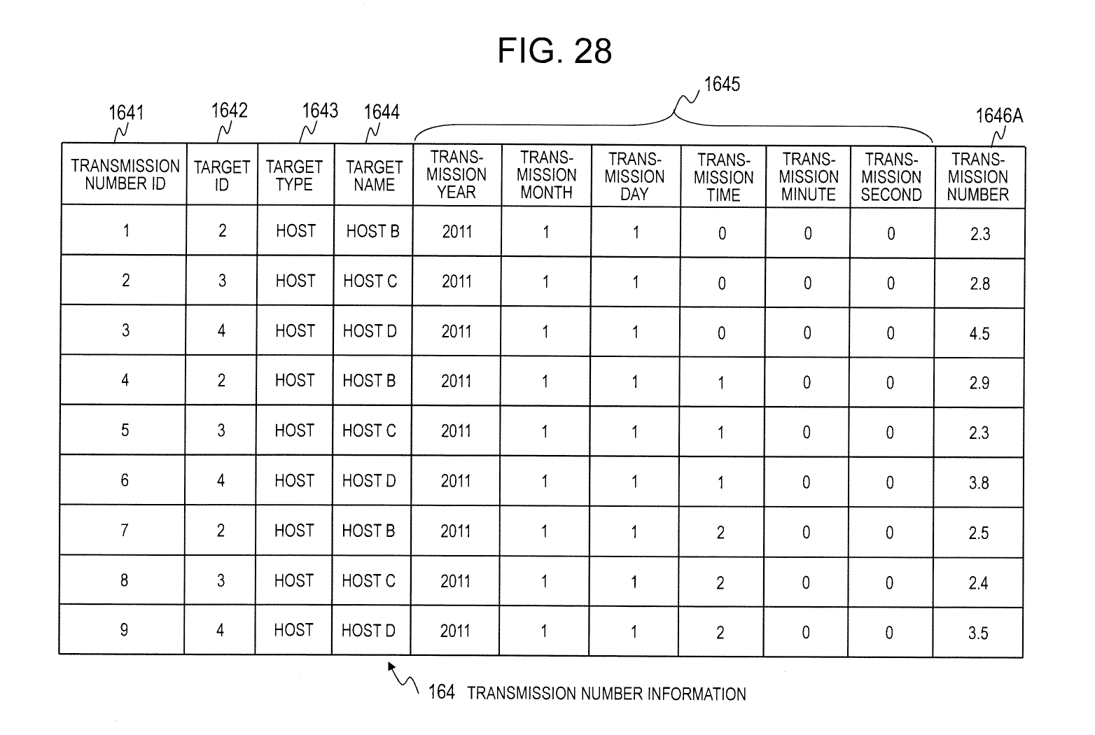

Here, the transmission number information 164 is a table as depicted in FIG. 28. As for the transmission number information 164 of this embodiment, the value obtained by adding the influence coefficient 1678 to the transmission number 1646 of the transmission number information 164 depicted in FIG. 20 of the first embodiment is stored as the transmission number 1646A. The others are similar to those of the table depicted in FIG. 20.

The influence analysis calculation part 125 repeats the above process for each target element of the configuration information 161 till the end time of each entry of the time influence coefficient information 167 in a manner similar to FIG. 14. Upon the completion of the loop of Steps S3 and S4 by the influence analysis calculation part 125, the release plan calculation part 122 executes Step S41.

In Step S41, the release plan calculation part 122 generates the release plan for each target element in the release plan result information 169 and stores the plan in the release plan result information 169 in a manner similar to FIG. 19 of the first embodiment.

Then, in Step S42, the release plan calculation part 122 outputs to the output device 13, the release plan result information 169 obtained for each target element as above by the release plan calculation part 122.

Through the above process, the release plan result information is output after the influence coefficient is added to the transmission number 1646 in the second embodiment. In the example of the second embodiment, the release plan as depicted in the release plan window 1312 of FIG. 17 of the first embodiment is displayed.

### Third Embodiment

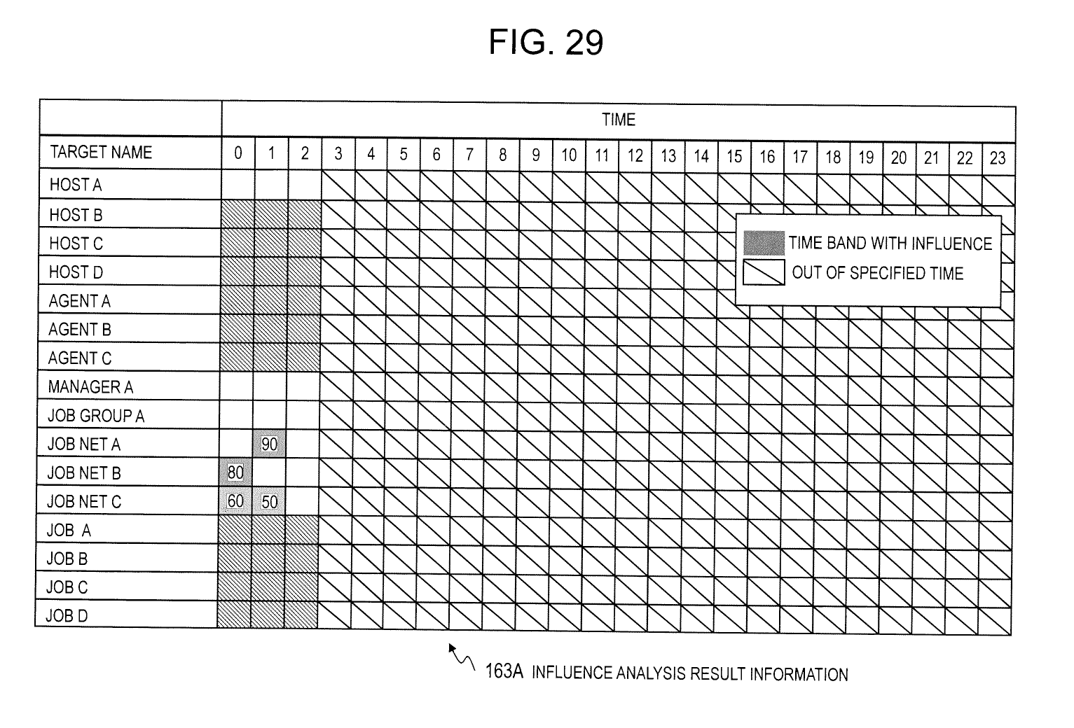

FIG. 29 to FIG. 33 depict a third embodiment. In the third embodiment, the influence analysis calculation part 125 calculates the influence analysis result information 163 in the case of adding the time influence coefficient information 167 of the second embodiment to the schedule information 162 of the first embodiment.

In FIG. 29, the output device 13 displays the influence analysis result information 163A obtained by adding the time influence coefficient information 167 of the second embodiment to the schedule information 162 of the first embodiment.

In this example, the influence analysis calculation part 125 calculates the influence analysis result information 163 on the basis of the time influence coefficient information 167 and then, removes the job net which is not executed from the influence range with reference to the schedule information 162 in a manner similar to the second embodiment. If there is the influence, the influence coefficient is displayed for each job net as depicted in FIG. 29.

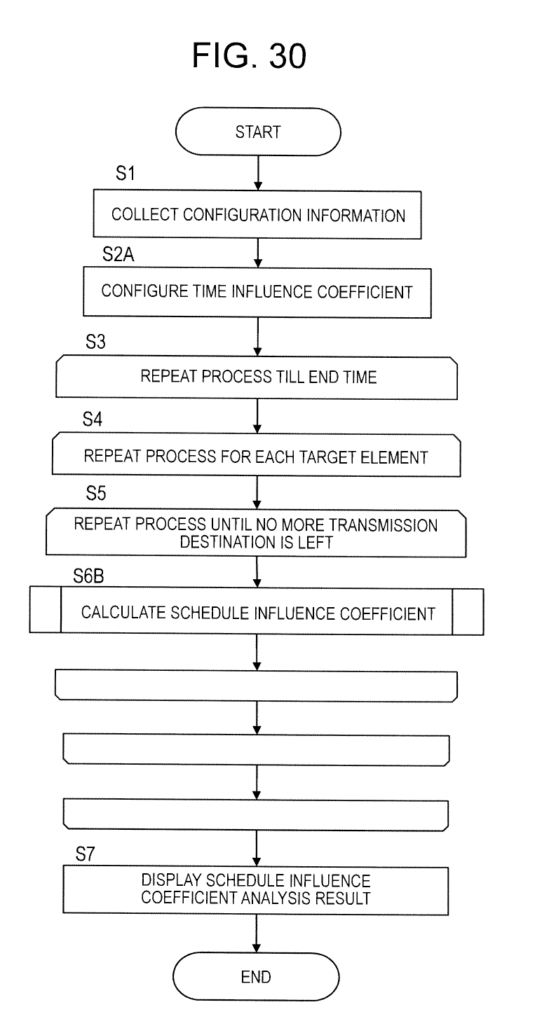

FIG. 30 is a flowchart for describing an example of the influence analysis process of the third embodiment executed in the influence analysis calculation part 125. The influence analysis process of the third embodiment is different from that of the second embodiment depicted in FIG. 24 in that the schedule information 162 is applied after the influence analysis result information 163 is obtained based on the time influence coefficient information 167 in Step S6B. The other structures are similar to those of the second embodiment.

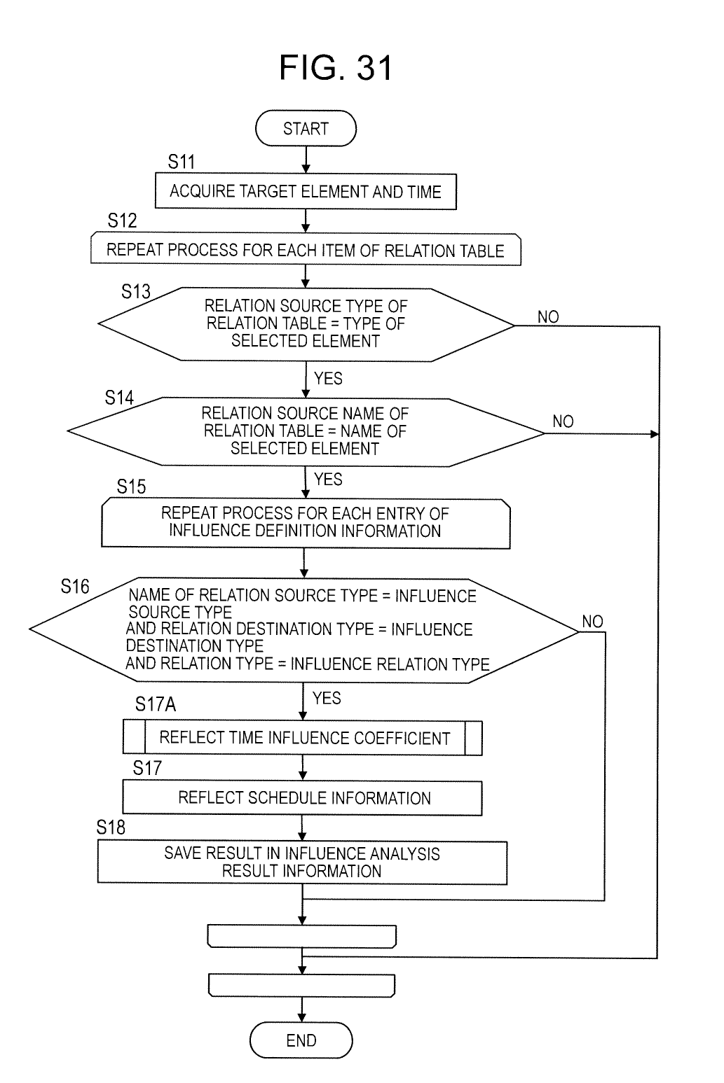

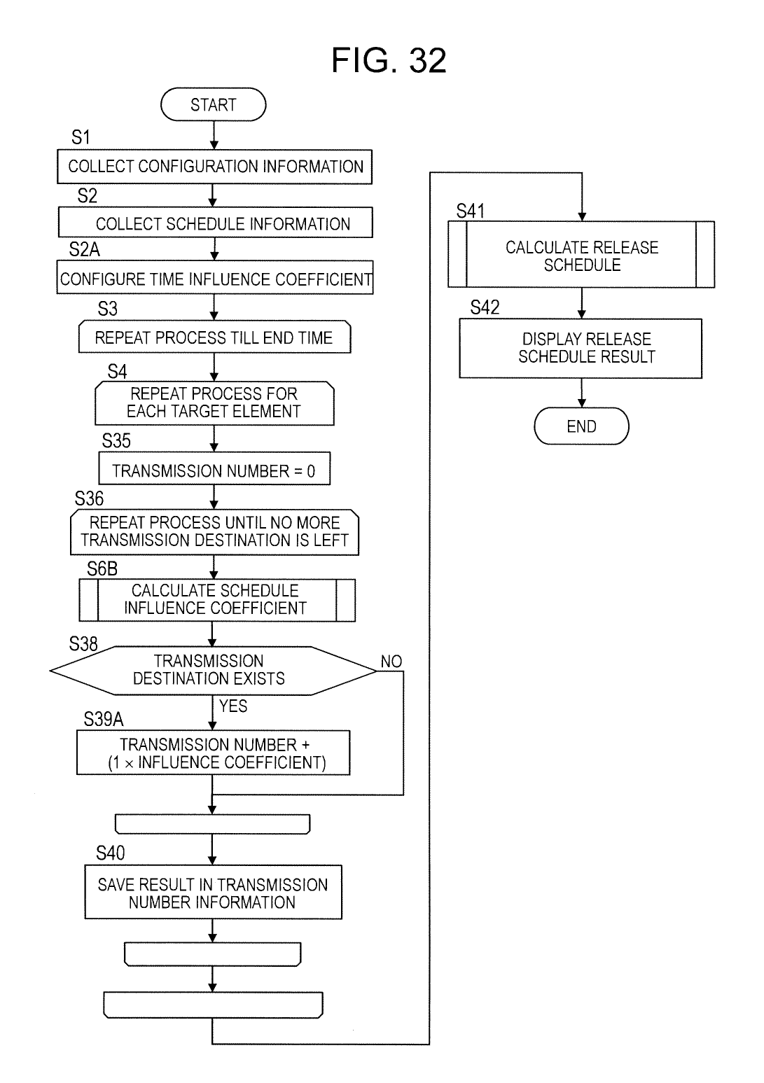

The influence analysis calculation part 125 receives the start time, the end time, and the analysis time intervals along with the order of starting the execution from the window 1311 depicted in FIG. 11. Then, the influence analysis calculation part 125 executes Steps S1 to S4 in a manner similar to the second embodiment. Then, after the influence analysis calculation part 125 calculates the influence analysis result information 163 on the basis of the time influence coefficient information 167, the schedule information 162 is applied as depicted (later described) in FIG. 31 in Step S6B.

In Step S7, the influence analysis calculation part 125 outputs the obtained influence analysis result information 163A to the output device 13 as depicted in FIG. 29 in a manner similar to the second embodiment.

FIG. 31 is a flowchart for describing an example of the process executed in Step S6B of FIG. 30.

In the process of FIG. 31, Step S17A for reflecting the time influence coefficient depicted in FIG. 26 of the second embodiment is executed before Step S17 depicted in FIG. 15 of the first embodiment. The other structures are similar to those of the second embodiment.

In other words, in the third embodiment, the influence analysis calculation part 125 configures the influence coefficient for each target element in Step S17A and if the target element is not included in the time band (execution start year, month, day, time, minute and second 1624 to 1629+predetermined time (for example, one hour)) of the schedule information 162 in Step S17, the target element is removed from the influence analysis result information 163.

Through the above process, in the time band in which the configured job nets A to C will be executed according to the schedule information 162, the influence coefficient of the time influence coefficient information 167 is configured and the screen of the influence analysis result information 163A as depicted in FIG. 29 is displayed on the output device 13.

Thus, by using the time influence coefficient information 167 in combination with the schedule information 162, the range of the influence when the hosts are stopped can be displayed in consideration of the influence coefficient and the execution schedule of the job nets A to C.

FIG. 32 depicts an example of performing a process of automatically generating a release plan of the host (job execution server 3) by using the impact analysis based on the schedule information 162 of the first embodiment and the time influence coefficient information 167 of the second embodiment. In this process, the schedule information 162 is added to the release plan generation process based on the time influence coefficient information 167 described in the second embodiment with reference to FIG. 18. The other structures are similar to those of the second embodiment.

In the process of FIG. 32, the release plan calculation part 122 acquires the schedule information 162 by adding the process of Step S2 of the first embodiment to the process of FIG. 27 of the second embodiment, and the schedule influence coefficient calculation process (S6B) depicted in FIG. 31 is executed instead of Step S6A of the second embodiment. The other structures are similar to those of the second embodiment.

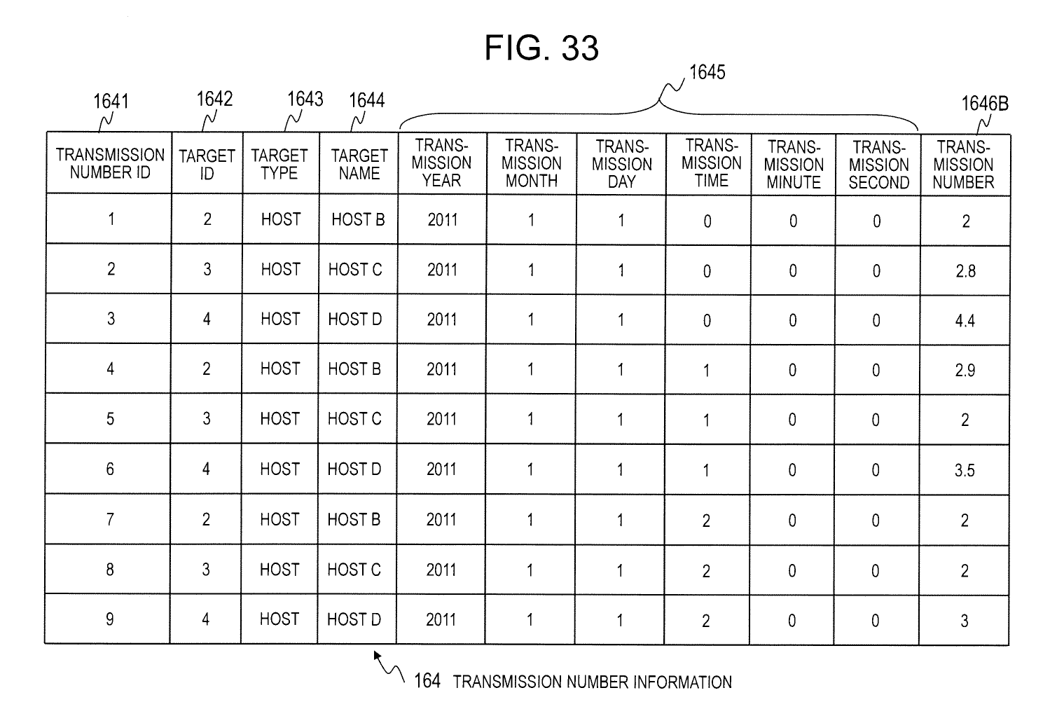

FIG. 33 depicts an example of the transmission number information 164 of the third embodiment. The transmission number information 164 of the third embodiment is different from that of the second embodiment depicted in FIG. 28 in that the presence or absence of the influence of the schedule information 162 (no influence in the case that the time is out of the schedule time for the execution of the job net) and the influence coefficient are added for the calculation of the transmission number 1646B. The release plan based on the result of the transmission number information 164 is similar to that of the first embodiment, and the release plan window 1312 of FIG. 17 is output.

### Fourth Embodiment

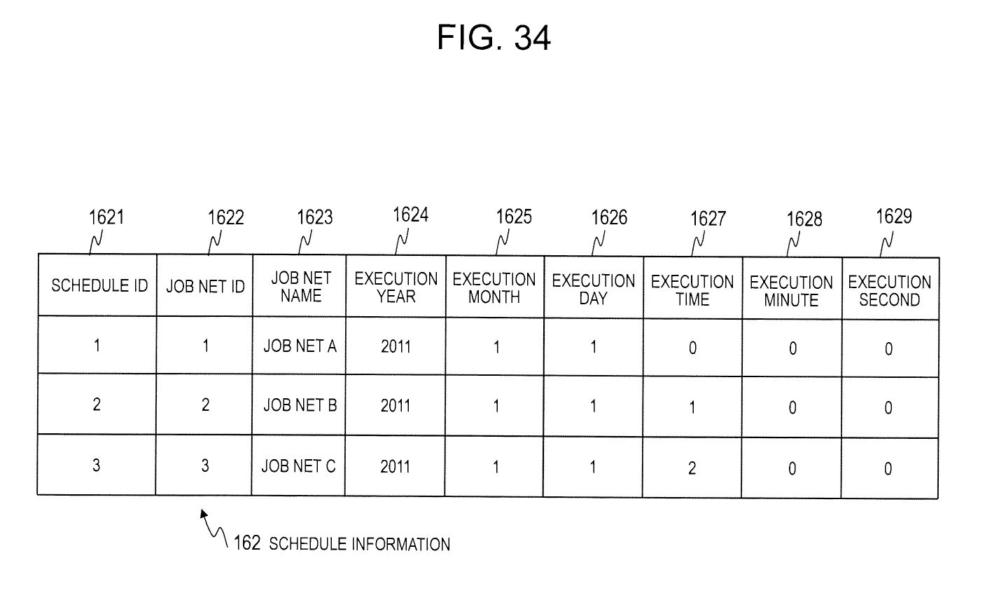

FIG. 34 to FIG. 36 depict a fourth embodiment, in which the first embodiment is applied retroactively. In this fourth embodiment, an example of a failure influence analysis in which the spread of the failure influence range is visualized retroactively.

FIG. 34 depicts the schedule information 162 used in the fourth embodiment, and the start times of the job nets A to C are different from those of the schedule information 162 used in the first embodiment.

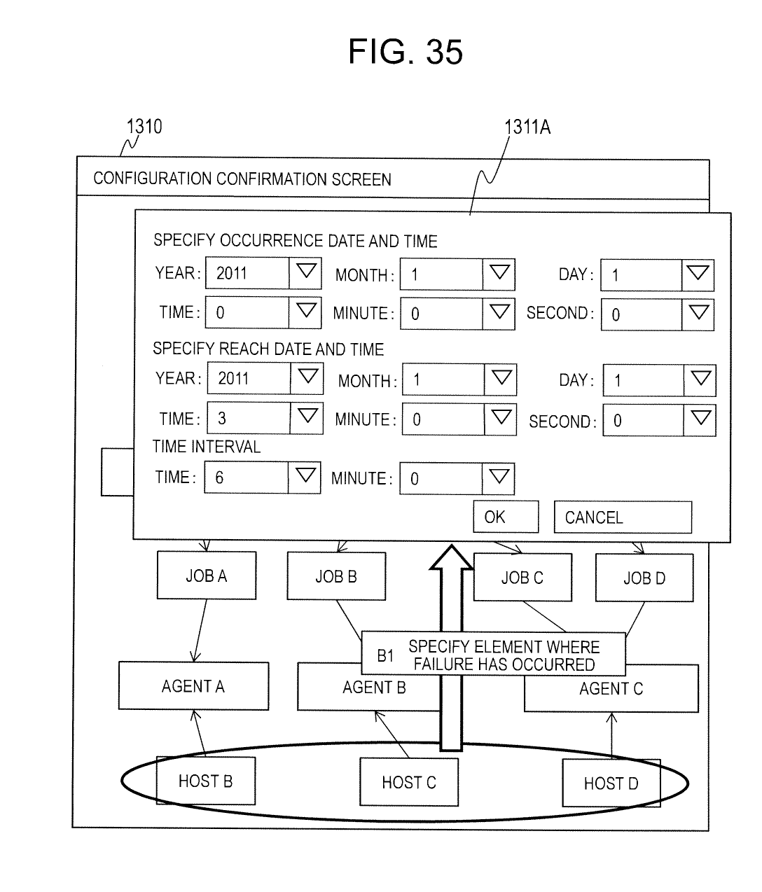

FIG. 35 is a diagram depicting the summary of the process performed in the influence analysis calculation part 125. The influence analysis calculation part 125 executes the influence analysis when the job execution server 3 is stopped in the time band received from the input device 14 operated by the administrator or the like, and outputs the analysis result to the output device 13.

First, the administrator or the like selects the target element (host) in the window 1310 of the configuration information depicted in FIG. 5 displayed on the output device 13 (B1 in the drawing). Here, an example in which the hosts B to D fail and are stopped is assumed. Next, in a time specifying window 1311A, the time band in which the failure has occurred in the selected hosts B to D and the analysis time intervals (time intervals) are configured. The configuration management server 1 acquires the occurrence date and the reach date from the time specifying window 1311A and the influence analysis calculation part 125 calculates the influence from the hosts B to D on the job nets at the analysis time intervals from the occurrence date to the reach date through the process described in the first embodiment, thereby providing the influence analysis result information 163.

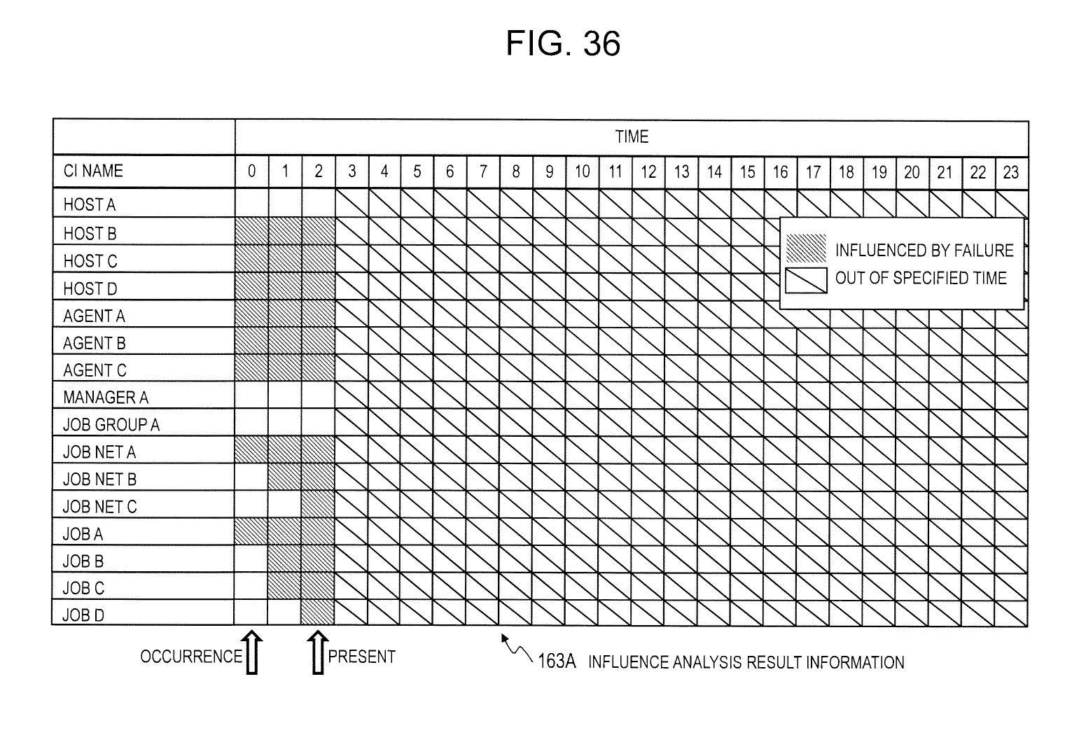

Then, the influence analysis calculation part 125 displays the element influenced from the time (occurrence date) at which the failure has occurred in the hosts B to D to the analysis end date (reach date) on the output device 13 as the influence analysis result information 163A of FIG. 36.

In FIG. 36, the influence analysis result at the occurrence of the failure is displayed at the analysis time intervals (every 60 minutes in this example) in a manner that the element influenced is drawn as a shaded part and the element not influenced is drawn as a blank part. In the occurrence of the failure, the administrator or the like can ascertain in the time-series manner what kind of configuration element is influenced with the use of the computer system.

Note that although the above embodiments have described the example in which the job execution servers 3, the job management server 2 and the configuration management server 1 each comprise a physical computer, they may alternatively comprise a virtual computer.

Moreover, although the above embodiments have described the example in which the business is provided by the plural jobs constituting the job net, one or more programs may alternatively provide the business or the service.

What is claimed is:

1. An impact analysis method in which a management computer including a processor and a memory analyzes an influence on software from hardware in a computer system, the method comprising:
a first step in which the management computer receives a time band for which the analysis is conducted;
a second step in which the management computer acquires configuration information that defines configuration elements of the hardware and configuration elements of the software, and relation information between the configuration elements of the hardware and the configuration elements of the software;
a third step in which the management computer acquires influence definition information that defines influences among the configuration elements of the configuration information;
a fourth step in which the management computer reads in time-series information that defines information related to operation of the software in time-series;
a fifth step in which the management computer determines an influence of the configuration elements of the hardware on the configuration elements of the software on a basis of operation states in time-series defined by the time-series information from the relation information and the influence definition information to determine a configuration element of the software that is influenced by the hardware among the configuration elements of the software in the time band; and
a sixth step in which the management computer outputs the configuration element of the software that is influenced by the hardware in time-series including the time band.

2. An impact analysis method according to claim 1, wherein:
in the fourth step, schedule information in which times of executing the configuration elements of the software are defined in time-series is acquired as the time-series information; and
in the fifth step, a configuration element of the software executed in the time band is determined based on the schedule information to determine the configuration element of the software that is influenced.

3. An impact analysis method according to claim 1, wherein:
in the fourth step, influence coefficient information in which an influence coefficient relative to a business provided by a configuration element of the software when a configuration element of the hardware that executes the configuration element of the software is stopped is defined in time-series for each of the configuration elements is acquired as the time-series information; and
in the fifth step, the configuration element of the software that is influenced by the hardware among the configuration elements of the software is determined within the time band and the influence coefficient is configured in time-series in the time band.

4. An impact analysis method according to claim 1, wherein:
in the fourth step, schedule information in which times of executing the configuration elements of the software are defined in time-series, and influence coefficient information in which an influence coefficient relative to a business provided by a configuration element of the software when a configuration element of the hardware that executes the configuration element of the software is stopped is defined in time-series for each of the configuration elements are acquired as the time-series information; and
in the fifth step, the configuration element of the software that is executed in the time band is determined based on the schedule information and the influence coefficient is configured in time-series in the time band.

5. An impact analysis method according to claim 2, further comprising a sixth step in which a configuration element of the hardware that has no influence on the software among the configuration elements of the hardware is determined in time-series in the time band.

6. An impact analysis method according to claim 3, further comprising a seventh step in which a configuration element of the hardware that has no influence on the software among the configuration elements of the hardware is determined in time-series in the time band.

7. An impact analysis method according to claim 4, further comprising an eighth step in which a configuration element of the hardware that has no influence on the software among the configuration elements of the hardware is determined in time-series in the time band.

8. An impact analysis method according to claim 2, wherein:
in the first step, the time band is received as a time band in which a failure occurs; and
in the fifth step, the configuration element of the software that is influenced by the failure from the hardware among the configuration elements of the software is determined in time-series in the time band where the failure occurs.

9. An impact analysis apparatus including a processor and a memory for analyzing an influence of hardware in a computer system on software, the apparatus comprising:
an input part configured to receive a time band for which the analysis is conducted;
a configuration information acquisition part configured to acquire configuration information that defines configuration elements of the hardware and configuration elements of the software, relation information between the configuration elements of the hardware and the configuration elements of the software, and influence definition information that defines influences among the configuration elements of the configuration information;
a time-series information acquisition part configured to acquire time-series information that defines information related to operation of the software in time-series; and
an influence analysis part configured to determine an influence of the configuration elements of the hardware on the configuration elements of the software on a basis of operation states in time-series defined by the time-series information from the relation information and the influence definition information to determine a configuration element of the software that is influenced by the hardware among the configuration elements of the software in the time band, wherein the influence analysis part outputs the configuration element of the software that is influenced by the hardware in time-series including the time band.

10. An impact analysis apparatus according to claim 9, wherein:
the time-series information is schedule information in which times of executing the configuration elements of the software are defined in time-series; and
the influence analysis part determines a configuration element of the software executed in the time band based on the schedule information to determine the configuration element of the software that is influenced.

11. An impact analysis apparatus according to claim 9, wherein:
the time-series information is influence coefficient information in which an influence coefficient relative to a business provided by a configuration element of the software when a configuration element of the hardware that executes the configuration element of the software is stopped is defined in time-series for each of the configuration elements; and
the influence analysis part determines the configuration element of the software that is influenced by the hardware among the configuration elements of the software in the time band and the influence coefficient is configured in time-series in the time band.

12. An impact analysis apparatus according to claim 9, wherein:
the time-series information includes schedule information in which times of executing the configuration elements of the software are defined in time-series, and influence coefficient information in which an influence coefficient relative to a business provided a the configuration element of the software when a configuration element of the hardware that executes the configuration element of the software is stopped is defined in time-series for each of the configuration elements; and
the influence analysis part determines the configuration element of the software that is executed in the time band based on the schedule information and the influence coefficient is configured in time-series in the time band.

13. An impact analysis apparatus according to claim 10, further comprising a release plan part for determining a configuration element of the hardware that has no influence on the software among the configuration elements of the hardware in time-series in the time band.

14. An impact analysis apparatus according to claim 11, further comprising a release plan part for determining a configuration element of the hardware that has no influence on the software among the configuration elements of the hardware in time-series in the time band.

15. A non-transitory computer-readable storage medium storing a program for analyzing an influence of hardware in a computer system on software, the program causing a computer to execute the steps of:
a first step of receiving a time band for which the analysis is conducted;
a second step of acquiring configuration information that defines configuration elements of the hardware and configuration elements of the software, and relation information between the configuration elements of the hardware and the configuration elements of the software;
a third step of acquiring influence definition information that defines influences among the configuration elements of the configuration information;
a fourth step of reading in time-series information that defines information related to operation of the software in time-series;
a fifth step of determining an influence of the configuration elements of the hardware on the configuration elements of the software on a basis of operation states in time-series defined by the time-series information from the relation information and the influence definition information to determine a configuration element of the software that is influenced by the hardware among the configuration elements of the software in the time band; and
a sixth step of outputting the configuration element of the software influenced by the hardware in time-series including the time band.
